(19) United States
(12) Patent Application Publication
(10) Pub. No.: US 2026/0255259 A1
(43) Pub. Date: Aug. 27, 2026

(54) 6G CONTROL PLANE NETWORK FUNCTIONS IN SERVICE-BASED ARCHITECTURE

(71) Applicant: Intel Corporation, Santa Clara, CA (US)

(72) Inventors: Sangeetha L. Bangolae, Portland, OR (US); Zongrui Ding, Portland, OR (US); Youn Hyoung Heo, Sunnyvale, CA (US); Abhijeet Ashok Kolekar, Hillsboro, OR (US); Qian Li, Beaverton, OR (US); Thomas Luetzenkirchen, Taufkirchen, BY (DE); Sudeep K. Palat, Cheltenham, Gloucestershire (GB); Alexandre Saso Stojanovski, Paris (FR); Xiaopeng Tong, Beijing 11 (CN)

(21) Appl. No.: 18/855,910

(22) PCT Filed: May 10, 2023
(86) PCT No.: PCT/US2023/021691

§ 371 Date: Oct. 10, 2024

Related U.S. Application Data
(60) Provisional application No. 63/340,861, filed on May 11, 2022.
(60) Provisional application No. 63/341,879, filed on May 13, 2022.
(60) Provisional application No. 63/342,490, filed on May 16, 2022.
(60) Provisional application No. 63/342,500, filed on May 16, 2022.
(60) Provisional application No. 63/392,604, filed on Jul. 27, 2022.
(60) Provisional application No. 63/482,685, filed on Feb. 1, 2023.

(51) Int. Cl. H04W 48/16; H04L 67/02; H04W 8/24; H04W 12/037; H04W 92/14

(52) U.S. Cl. CPC H04W 48/16; H04L 67/02; H04W 8/24; H04W 12/037; H04W 92/14

(57) ABSTRACT

An apparatus and system of providing a service-based architecture in a 6G system are described. Control plane details are provided for a central unit-control plane (CU-CP) of a next generation NodeB (xNB) that has direct access to network functions (NFs) over a service based interface (SBI). Protocol details for distributed non-access stratum (NAS) and hypertext transfer protocol (HTTP) messages between a user equipment (UE) and NF are provided. In addition, details for enhanced distributed unit (eDU) are provided to support multiple distributed user plane (UP) entities and corresponding UP configuration for a UE.

### PRIORITY CLAIM

This application claims the benefit of priority to U.S. Provisional Application Ser. No. 63/340,861, filed May 11, 2022, U.S. Provisional Application Ser. No. 63/341,879, filed May 13, 2022, U.S. Provisional Application Ser. No. 63/342,490, filed May 16, 2022, U.S. Provisional Application Ser. No. 63/342,500, filed May 16, 2022, U.S. Provisional Application Ser. No. 63/392,604, filed Jul. 27, 2022, and U.S. Provisional Application Ser. No. 63/482,685, filed Feb. 1, 2023, each of which is incorporated herein by reference in its entirety.

### TECHNICAL FIELD

Embodiments pertain to wireless communications. In particular, some embodiments relate to control plane functionality in next generation (6G) cellular networks.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology. In particular, enhancements of 6G systems that provide computing/data services in addition to communication services continue to be developed.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming system architecture in accordance with some aspects.

FIG. 1C illustrates a non-roaming system architecture in accordance with some aspects.

FIG. 2 illustrates a block diagram of a communication device in accordance with some embodiments.

FIG. 3 illustrates a non-roaming system architecture in accordance with some embodiments.

FIG. 4 illustrates a distributed non-access stratum (NAS) solution in accordance with some embodiments.

FIG. 5 illustrates uplink/downlink (UL/DL) distributed NAS information transfer in accordance with some embodiments.

FIG. 6 illustrates a protocol stack in accordance with some embodiments.

FIG. 7 illustrates a message exchange in accordance with some embodiments.

FIG. 8 illustrates another protocol stack in accordance with some embodiments.

FIG. 9 illustrates another message exchange in accordance with some embodiments.

FIG. 10 illustrates transport in accordance with some embodiments.

FIG. 11 shows a message process in accordance with some embodiments.

FIG. 12 shows another message process in accordance with some embodiments.

FIG. 13 shows network function (NF) discovery in accordance with some embodiments.

FIG. 14 illustrates another protocol stack in accordance with some embodiments.

FIG. 15 illustrates another protocol stack in accordance with some embodiments.

FIG. 16 shows another message process in accordance with some embodiments.

FIG. 17 shows another message process in accordance with some embodiments.

FIG. 18 shows a message exchange in accordance with some embodiments.

FIG. 19 illustrates a protocol stack in accordance with some embodiments.

FIG. 20 illustrates hypertext transfer protocol (HTTP) traffic filter configuration in accordance with some embodiments.

FIG. 21 illustrates a protocol stack in accordance with some embodiments.

FIG. 22 illustrates a protocol stack in accordance with some embodiments.

FIG. 23 illustrates an enhanced service communication proxy control plane (eSCP-C) configuration in accordance with some embodiments.

FIG. 24 shows a message process in accordance with some embodiments.

FIG. 25 illustrates a UE to network service based interface (SBI)-based solution in accordance with some embodiments.

FIG. 26 illustrates an uplink/downlink (UL/DL) Radio Resource Control (RRC) message for UE N1 SBI information transfer in accordance with some embodiments.

FIG. 27 illustrates an UL/DL RRC message for UE N1 SBI information transfer for a packet data unit (PDU) session in accordance with some embodiments.

FIG. 28 illustrates a protocol stack in accordance with some embodiments.

FIG. 29 illustrates an UL/DL compute information transfer in accordance with some embodiments.

FIG. 30 illustrates an UL/DL compute information transfer in accordance with some embodiments.

FIG. 31 illustrates a protocol stack in accordance with some embodiments.

FIG. 32 illustrates an UL/DL compute information transfer in accordance with some embodiments.

FIG. 33 illustrates UL/DL information transfer using a gateway in accordance with some embodiments.

FIG. 34 illustrates a protocol stack in accordance with some embodiments.

FIG. 35 shows a message process in accordance with some embodiments.

FIG. 36 shows a message process in accordance with some embodiments.

FIG. 37 illustrates a high-level architecture with radio access network (RAN) disaggregation in accordance with some embodiments.

FIG. 38 illustrates RAN disaggregation with enhanced distributed unit (eDU) support in accordance with some embodiments.

FIG. 39 illustrates RAN disaggregation with eDU support and separate Central Unit-User Plane (CU-UP) in accordance with some embodiments.

FIG. 40 illustrates a control plane and user plane protocol stack from the UE perspective in accordance with some embodiments.

FIG. 41 illustrates another control plane and user plane protocol stack from the UE perspective in accordance with some embodiments.

FIG. 42 illustrates a control plane protocol stack for the UE in accordance with some embodiments.

FIG. 43 illustrates another control plane protocol stack for the UE in accordance with some embodiments.

FIG. 44 illustrates signaling flow to support the eDU-control plane (eDU-CP) in accordance with some embodiments.

FIG. 45 shows a message process in accordance with some embodiments.

FIG. 46 shows a Medium Access Control (MAC) subheader for a MAC Control Element (MAC CE) in accordance with some embodiments.

FIG. 47 shows a MAC packet data unit (PDU) containing MAC subPDUs with MAC CEs in accordance with some embodiments.

FIG. 48 shows control plane signaling flow at an eDU in accordance with some embodiments.

FIG. 49 shows a message process in accordance with some embodiments.

FIG. 50 shows another message process in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

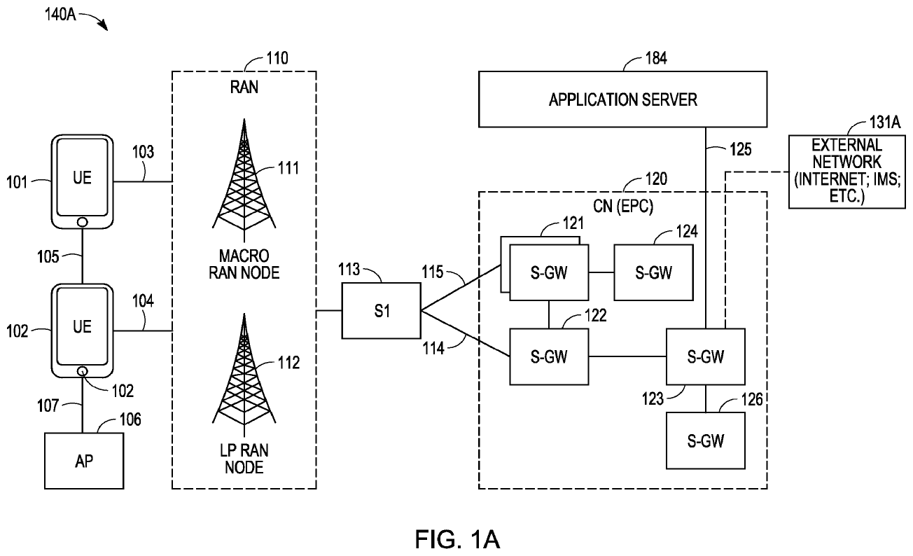

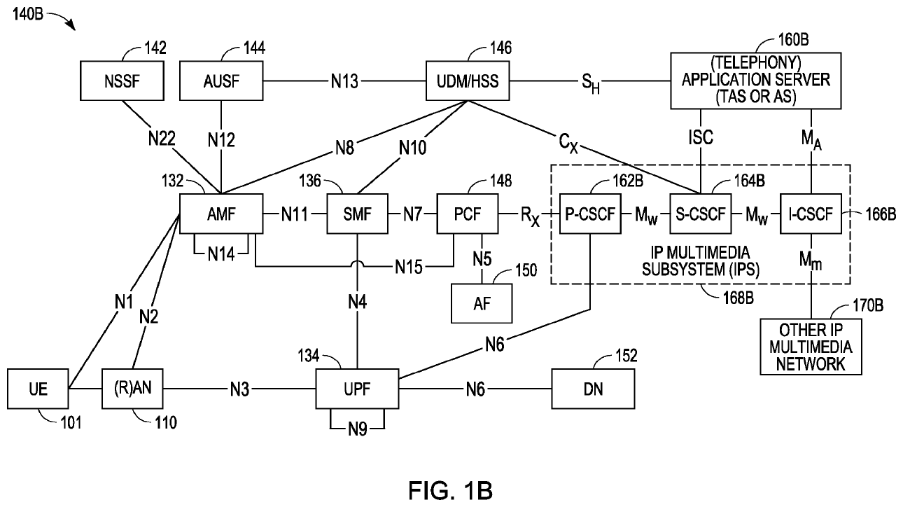

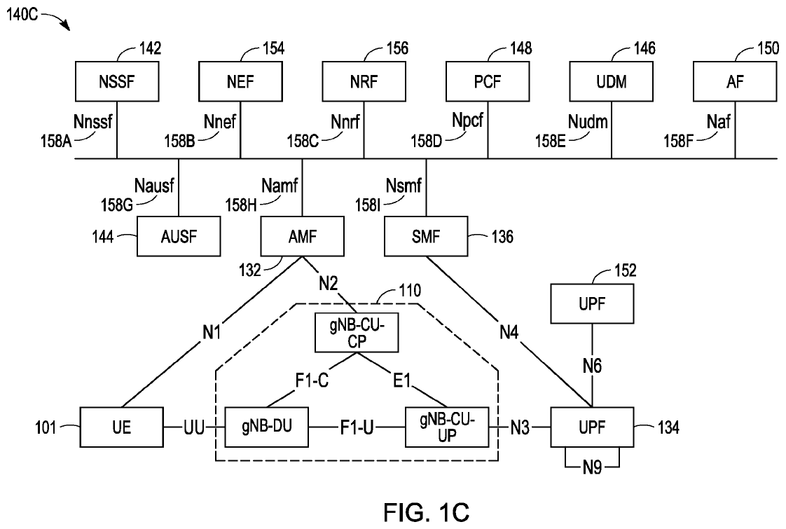

FIG. 1A illustrates an architecture of a network in accordance with some aspects. The network 140A includes 3GPP LTE/4G and NG network functions that may be extended to 6G and later generation functions. Accordingly, although 5G may be referred to, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHZ, 3.6-3.8 GHz, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units-a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signaling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signaling connection and UE-associated services that are related to a single UE and are associated with a UE-associated signaling connection that is maintained for the UE.

The F1 interface may be disposed between the CU and the DU. The CU may control the operation of the DU over the F1 interface. As the signaling in the gNB is split into control plane and user plane signaling, the F1 interface may be split into the F1-C interface for control plane signaling between the gNB-DU and the gNB-CU-CP, and the F1-U interface for user plane signaling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as E2 nodes, base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in an architecture.

FIG. 1B illustrates a non-roaming system architecture in accordance with some aspects. In particular, FIG. 1B illustrates a system architecture 140B in a reference point representation, which may be extended to a 6G system architecture. More specifically, UE 102 can be in communication with RAN 110 as well as one or more other CN network entities. The system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g., an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a system architecture 140C and a service-based representation. In addition to the network entities illustrated in FIG. 1B, system architecture 140C can also include a network exposure function (NEF) 154 and a network repository function (NRF) 156. In some aspects, system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

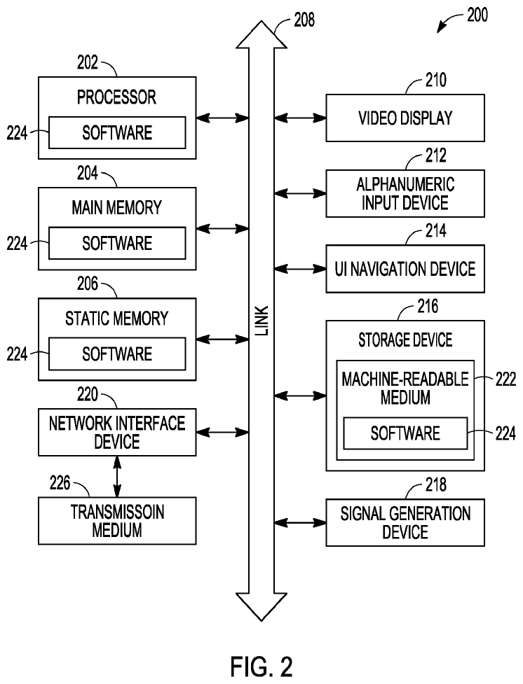

FIG. 2 illustrates a block diagram of a communication device in accordance with some embodiments. such as an evolved Node-B (eNB), a new generation Node-B (gNB) (or another RAN node), an access point (AP), a wireless station (STA), a mobile station (MS), or user equipment (UE), in accordance with some aspects and to perform one or more of the techniques disclosed herein. In alternative aspects, the communication device 200 may operate as a standalone device or may be connected (e.g., networked) to other communication devices. The communication device may be any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHZ, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHZ, 31-31.3 GHZ, 37-38.6 GHZ, 38.6-40 GHz, 42-42.5 GHZ, 57-64 GHz, 71-76 GHZ, 81-86 GHz and 92-94 GHZ, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Networks extend beyond the traditional mobile broadband services to provide various new services such as internet of things (IoT), industrial control, autonomous driving, mission critical communications, etc. that may have ultra-low latency, ultra-high reliability, and high data capacity requirements due to safety and performance concerns. Some of the features in this document are defined for the network side, such as APs, eNBs, NR or gNBs—note that this term is typically used in the context of 3GPP 5G and 6G communication systems, etc. Still, a UE may take this role as well and act as an AP, eNB, or gNB; that is some or all features defined for network equipment may be implemented by a UE.

Support of UE Communication to Control Plane Network Functions with N2 SBI in Service-Based Architecture

As above, NG system architecture supports service-based interactions between different control plane network functions. The AMF serves as the single point of entry for communication to the rest of the network functions from the xNB/CU-CP. Different network functions such as the SMF, NRF, PCF, UDM, AUSF etc. all belong to the service-based architecture (SBA) as described in TS 23.501. The UE communicates over the Non-Access Stratum (NAS) with the AMF and thereby other network functions (NFs). For 6G, the xNB or CU-CP may also be part of the SBA. When this is enabled, the CU-CP can have direct access to all the network functions over the Service Based Interface (SBI). The over-the-air protocol/RRC details are provided herein to support the UE communication with the different network functions in such a service-based architecture.

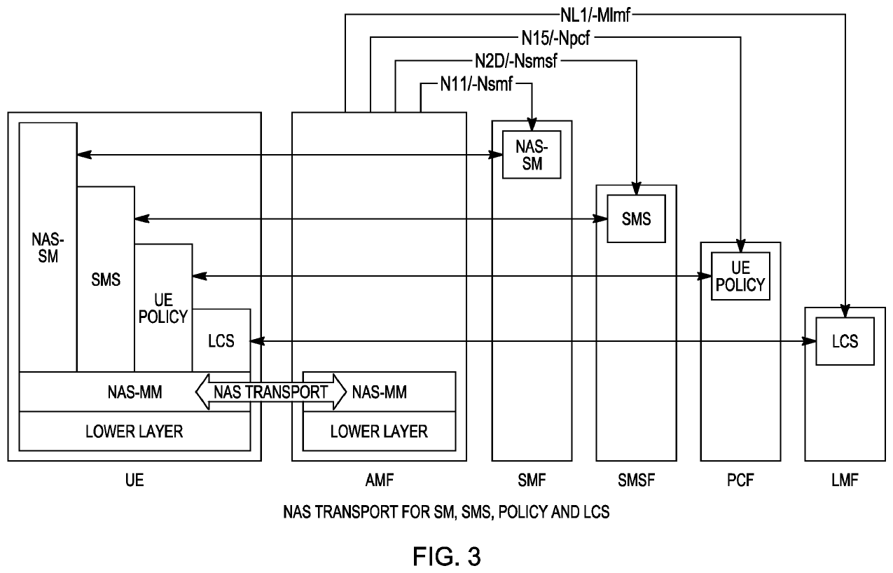

FIG. 3 illustrates a non-roaming system architecture in accordance with some embodiments. The architecture in FIG. 3 corresponds to a non-roaming system architecture in which the AMF is the single source of entry for the control plane and the RAN (or xNB) has an N2 interface towards the core network (with AMF as the entry point). The UE sends NAS messages through the RAN/xNB towards the AMF.

The NAS transport example is shown in FIG. 3 in the UE sends a NAS-MM message towards the AMF, which may contain messages aimed at other network functions. These messages are differentiated by the AMF using the payload container as defined in Table 9.11.3.40.1 of TS 24.501 (reproduced below as Table 1). For example, when the UE provides the payload within the NAS message sent to the AMF, the payload indicates the payload container type information element for the type of payload included inside the NAS message (like N1 SM information is aimed towards SMF or Session Management Function).

TABLE 1
Payload container type value (octet 1)

| Bits | | | | |
|---|---|---|---|---|
| 4 | 3 | 2 | 1 | |
| 0 | 0 | 0 | 1 | N1 SM information |
| 0 | 0 | 1 | 0 | SMS |
| 0 | 0 | 1 | 1 | LTE Positioning Protocol (LPP) message container |
| 0 | 1 | 0 | 0 | SOR transparent container |
| 0 | 1 | 0 | 1 | UE policy container |
| 0 | 1 | 1 | 0 | UE parameters update transparent container |
| 0 | 1 | 1 | 1 | Location services message container (see |
| | | | | 3GPP TS 23.273 [6B]) |
| 1 | 0 | 0 | 0 | CIoT user data container |
| 1 | 1 | 1 | 1 | Multiple payloads |

All other values are reserved.
NOTE:
The value “Multiple payloads” is only used when the Payload container contents in FIG. 9.11.3.39.1 contains multiple payloads as shown in FIG. 9.11.3.39.2.

As shown in FIG. 3, there is a singular NAS message that is disseminated from the AMF towards other NFs. The UE does not have to provide the exact identifier of the other network functions as the AMF takes care of choosing the suitable destination NF based on the UE subscription, request and other factors. Once the AMF chooses the NF instance, the AMF stores the information as part of the UE context.

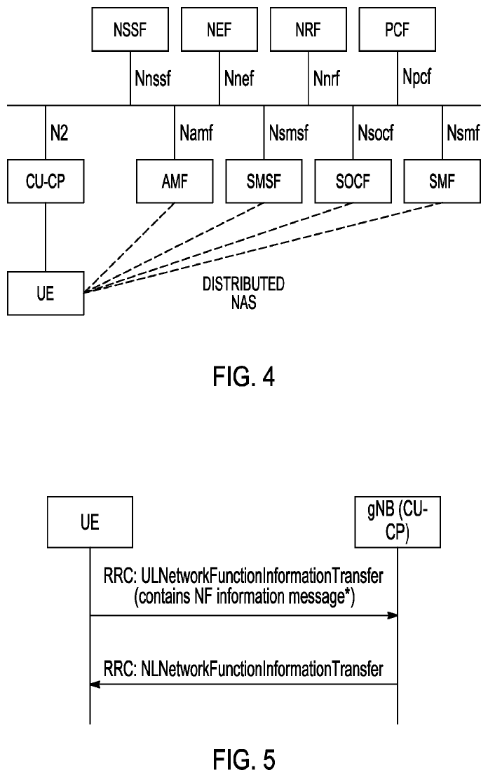

Accordingly, various solution options of the UE transport message for the 6G architecture by which the CU-CP is part of the SBA (N2 is SBI). FIG. 4 illustrates a distributed NAS solution in accordance with some embodiments, gNB and xNB are to be considered to mean the same node. CU-CP refers to the xNB control plane unit and is also to be considered interchangeable with gNB and xNB. gNB is terminology from 5G while xNB refers to 6G and beyond.

In one embodiment, the UE can reach the network functions via individual NAS messages towards each of the interested NFs. This is generally referred to as a distributed NAS mechanism. We assume here that the interface between xNB/RAN and CN (i.e., N2) is also based on the SBI such that the xNB may act as the point of entry for the UE towards the rest of the functions on the SBI including the AMF. Considering the architecture as shown in FIG. 4, the NF service can be reached by the UE as discussed further below. This process happens after initial/resume connection establishment and the UE has exchanged its capability with the gNB/network to determine the support of any of the following discussed options (to forward NAS message request in this manner) from both the UE and network perspective.

Service discovery can be performed, and the NF ID of the different network functions may be available to the UE or CU-CP as part of the UE context information. For example, the CU-CP can query the Network Repository Function (NRF) for the appropriate NF instance in the network with certain criteria. In another example, the NF ID of the assigned NF instance may be directly configured to the UE. This information may be provided at registration based on the UE subscription by the AMF (or similar function to be considered in 6G) and/or at RRC Reconfiguration by the xNB/CU-CP.

There are different options to enable the transport of distributed NAS from the UE towards different NFs, as described below. All of the information details are applicable to both existing services and new services such as compute supporting functions with corresponding service operations.

During initial registration procedure, the UE obtains the identifier of the function [e.g., SMF] and stores this identity information for different network functions. It is understood that the UE performs registration using procedures via the AMF-like function.

FIG. 5 illustrates UL/DL distributed NAS information transfer in accordance with some embodiments. Once in RRC connected mode after registration, a newly defined RRC message that includes the network function identifier and the message contents for the xNB/CU-CP to utilize and forward towards the desired network function by encapsulating the message from the UE, as shown in FIG. 5. The UE sends a generic NAS message similar to the already-defined ULInformationTransfer, however, the contents of the new message are different and discussed below in the different options.

Option 1) Using RRC message for transfer of distributed NAS to NFs. In one example embodiment, a RRC message with no NAS container is primarily used to transfer a distributed NAS towards the NF. The AMF (or similar function for access and mobility management) is treated as one of the network functions and the CU-CP identifies the AMF using the information element/protocol discriminator and forwards the message towards that function.

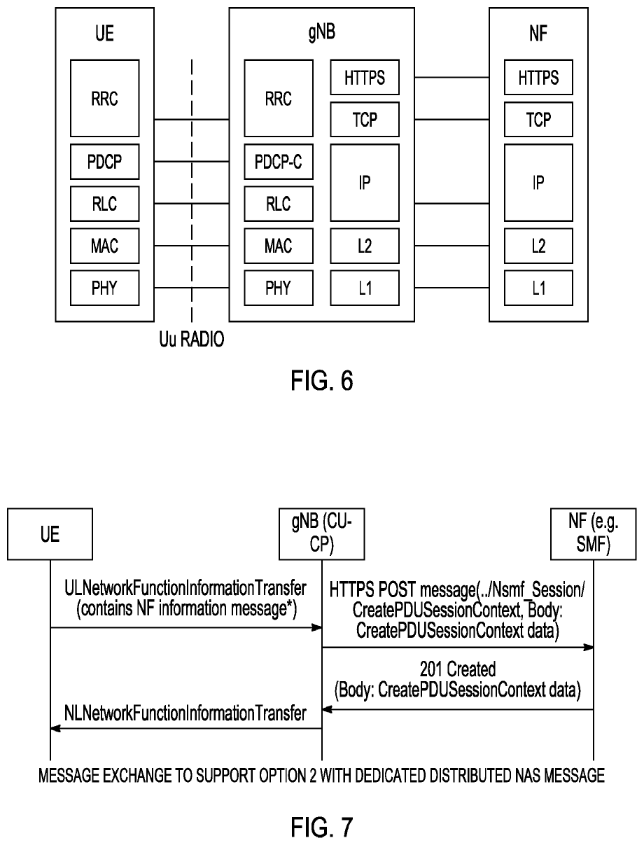

FIG. 6 illustrates a protocol stack for option 1 in accordance with some embodiments. FIG. 6 showcases the protocol stack in which the UE primarily uses the RRC message with information elements related to the Network Function to communicate with the target Network Function via the xNB/CU-CP.

As the CU-CP has an N2 interface as an SBI, the CU-CP uses HTTPS on the NF side of the stack to forward the UE message to the corresponding NF. The HTTPS may be based on TCP/IP or QUIC as applicable for 6G support. The message from the UE to CU-CP is encrypted using Access Stratum (AS) security over RRC and xNB to the NF may be based on HTTPS over TLS or other method.

RRC message details: the RRC message may be defined over an existing or new Signaling Radio Bearer (SRB) (e.g., UL/DL DCCH message). In another example, a new type of radio bearer such as a distributed NAS Radio bearer or NRB may be defined to carry this message over the air towards the CU-CP via the DU.

Contents of the RRC message: sent as individual IEs or a container as per below (these are exemplary elements shown assuming the target NF is a SMF or Session Management Function): the UE ID (e.g., assumed as core network value such as NG-5G-S-TMSI or 5G-GUTI or SUPI, but may be a newly defined UE ID that is visible to the SBA i.e., both RAN and CN). The NF identification can include all or a combination of the following (protocol discriminator): a) a 4-bit NF message type ID referring to the payload container type (Note: 4 bits is exemplary and may be set to ‘n’ bits). b) an NF type (AMF, SMF, SMSF, PCF . . . ) if desired (if NF ID is provided, inclusion may be avoided). It is possible for the UE to have only one UL RRC message and only one DL RRC message defined to support transaction to every NF (the IEs should encompass all the different aspects of the NFs) or multiple UL/DL RRC messages defined corresponding to each NF or a group of NFs. The former is showcased herein in which the NF type specifies the type of NAS message aimed towards a specific NF. The contents of the message may vary depending on the NF the UE is trying to reach. c) NF ID as a unique identifier or IP address or FQDN [similar to UE requested DNN]. Service operation Request (Session establishment/Create request, Session modification/Update request, Session Release request etc. . . . ) may be used for 4-bit for service operation, if applicable—in other cases, other operations include subscribe, unsubscribe, notify, updateNotify, etc. Service operation Request type (initial request, existing session . . . ) if applicable.

For each NF type/service, there may be different service operations that the CU-CP is to perform once the CU-CP is on the SBI. For example, if a PDU session is to be created, then, the CU-CP has to know whether to ‘create’, ‘release’ or ‘update’ and similarly whether to ‘create’, ‘update’ or ‘release’ UE context etc. Some of the information for these operations can be determined by the CU-CP, while some are obtained from the UE and/or Core network functions.

As an example, for session establishment, the UE may provide the following information: Slice ID (default, configured) as applicable; Session ID if applicable; Old Session ID if applicable; Request type (initial request, existing session . . . ) if applicable; Request (Session establishment/Create request, Session modification/Update request, Session Release request etc. . . . ) for 4-bit for service operation, if applicable. In other cases, other operations include subscribe, unsubscribe, notify, updateNotify, etc.

The above information is exemplary and depending on the type of NF to be contacted, the request for service operation may be changed. Since this option is completely RRC based, it is terminated at the xNB (CU-CP) PDCP layer (with encryption at PDCP level). Message details are entirely visible to the xNB (i.e., not transparent) and the xNB can build the HTTP(S) message towards the NF using the information received from the UE on behalf of the UE.

### ULNetworkFunctionInformationTransfer

The ULNetworkFunctionInformationTransfer message is used for the uplink transfer of network function related information/request. Signaling radio bearer: SRBx or SRB2. If SRBx is suspended, the UE does not send this message until SRBx is resumed. RLC-SAP: AM Logical channel: DCCH Direction: UE to network.

ULNetworkFunctionInformationTransfer message (option 1)
-- ASN1START
-- TAG-ULINFORMATIONTRANSFER-START
ULNetworkFunctionInformationTransfer::=

| | |
|---|---|
| criticalExtensions | CHOICE { |

ULNetworkFunctionInformationTransfer
ULNetworkFunctionInformationTransfer-IEs,

| | |
|---|---|
| criticalExtensionsFuture | SEQUENCE { } |

}
}

| | |
|---|---|
| ULNetworkFunctionInformationTransfer-IEs ::= | SEQUENCE { |
| selectedPLMN-Identity | INTEGER (1..maxPLMN), |
| registeredAMF | RegisteredAMF |

OPTIONAL,

| | |
|---|---|
| guami-Type | ENUMERATED {native, mapped} |

OPTIONAL,

| | |
|---|---|
| s-NSSAI-List | SEQUENCE (SIZE (1..maxNrofS-NSSAI)) OF |

S-NSSAI OPTIONAL,

| | |
|---|---|
| ng-6G-S-TMSI-Value | CHOICE { |
| ng-6G-S-TMSI | NG-6G-S-TMSI, |
| ng-6G-S-TMSI-Part2 | BIT STRING (SIZE (9)) |
| } | OPTIONAL, |
| networkFunctionMessageType-r19 | OCTET STRING (SIZE (4)) |
| networkFunctionNode-r19 | ENUMERATED {AMF, SMF, SMSF, |
| | PCF, spare, spare, spare, spare, spare, |
| | spare, spare}, |
| | OPTIONAL, |
| networkFunctionId-r19 | OCTET STRING (SIZE (8)), |

OPTIONAL,

| | |
|---|---|
| requestType | ENUMERATED {initial, existing}, |

OPTIONAL,

| | |
|---|---|
| requestOperation | ENUMERATED {create, modify, |

```
release}, OPTIONAL,
    ....
    ....
    ....
```

| | | |
|---|---|---|
| lateNonCriticalExtension | OCTET STRING | OPTIONAL, |
| nonCriticalExtension | SEQUENCE { } | OPTIONAL |

}
-- TAG-ULINFORMATIONTRANSFER-STOP
-- ASN1STOP

The UE ID can be same as that defined in the core network or modified to accommodate the corresponding area within which the ID is applicable/visible. As per TS 38.331 (and TS 23.003), the S-NSSAI identifies the network slice and contains the slice/service type and slice differentiator as shown below.

| -- ASN1START | |
|---|---|
| -- TAG-S-NSSAI-START | |
| S-NSSAI ::= | CHOICE{ |
| sst | BIT STRING (SIZE (8)), |
| sst-SD | BIT STRING (SIZE (32)) |

}
-- TAG-S-NSSAI-STOP
-- ASN1STOP

Option 2) Using NAS message for transfer of distributed NAS service message: In another example embodiment, the RRC message with NAS container is used by the UE to transfer the distributed NAS towards different Network functions.

During initial registration procedure, the UE obtains the identifier of the function [e.g., SMF] and stores this identity information for different network functions. It is understood that the UE performs registration using an existing procedure via the AMF-like function.

Once in RRC connected mode after registration, a newly defined RRC message that includes the network function identifier and the message contents for the xNB/CU-CP to utilize and forward towards the desired network function by encapsulating the message from the UE, is shown in FIG. 5. The UE sends a generic NAS message similar to ULInformationTransfer already defined, however, the contents of the new message are different and discussed below in the different options.

RRC message details: the new message may be defined over existing or new SRB (e.g., UL/DL DCCH message). In another example, a new type of radio bearer such as a distributed NAS Radio bearer (NRB) may be defined to carry this message over the air towards the CU-CP via the DU. Encrypted NAS container within the RRC message: sent towards the individual NF or proxy function.

The xNB-DU identifies the message and forwards the message transparently to the xNB-CU over F1-C. The following points apply: the (dedicated)NF-Message is set to include the information received from the upper layer. In the same way as the uplink message, when received in downlink, the message is forwarded to the upper layer of the UE. The (dedicated)NF-Message may be considered as transparent to the CU, which forwards the message to the corresponding NF. Integrity protection and ciphering may be performed using RRC and NAS. Reliable In-sequence delivery is provided.

ULNetworkFunctionInformationTransfer message (option 2)
-- ASN1START
-- TAG-ULINFORMATIONTRANSFER-START

| | |
|---|---|
| ULComputeNetworkFunctionInformationTransfer::= | SEQUENCE { |

| | |
|---|---|
| criticalExtensions | CHOICE { |

ULComputeNetworkFunctionInformationTransfer
ULComputeNetworkFunctionInformationTransfer-IEs,

| | |
|---|---|
| criticalExtensionsFuture | SEQUENCE { } |

}
}

| | |
|---|---|
| ULComputeNetworkFunctionInformationTransfer-IEs ::= | SEQUENCE { |

| | |
|---|---|
| networkFunctionId-r19 | OCTET STRING (SIZE (8)), |
| (dedicated-distributed-NAS)NF-Message | OCTET STRING, |
| lateNonCriticalExtension | OCTET STRING |

OPTIONAL,

| | |
|---|---|
| nonCriticalExtension | SEQUENCE { } |

OPTIONAL
}
-- TAG-ULINFORMATIONTRANSFER-STOP
-- ASN1STOP

The RRC message on the outside may at least contain the following information elements: NF identification can include all or a combination of the following (protocol discriminator): a) 4-bit NF message type ID referring to the payload container type (Note: 4 bits is exemplary and may be set to ‘n’ bits); b) NF type (AMF, SMF, SMSF, PCF . . . ) if desired (if NF ID is provided, this may be avoided); c) NF ID as unique identifier or IP address or FQDN [similar to UE requested DNN]. Or in the following manner: Service operation Request (Session establishment/Create request, Session modification/Update request, Session Release request etc. . . . ) for 4-bit for service operation, if applicable. In other cases, other operations include subscribe, unsubscribe, notify, updateNotify, etc. Service operation Request type (initial request, existing session . . . ) if applicable.

The encrypted dedicated distributed NAS message may at least contain the following information: UE ID (e.g., assumed as a core network value such as NG-5G-S-TMSI or 5G-GUTI or SUPI, but may be a newly defined UE ID that is visible to the SBA i.e., both RAN and CN). In addition, as an example, for session establishment, the UE may provide the following information within the encrypted NAS message: Slice ID (default, configured) as applicable; Session ID if applicable; and Old Session ID if applicable.

The above information is exemplary and depending on the type of NF to be contacted, the request for service operation and the contents of the message may be changed.

FIG. 7 illustrates a message exchange in accordance with some embodiments. FIG. 7 shows the message exchange between the UE and RAN. An example case of how the xNB (or xNB for 6G) builds the HTTPS POST message based on the RRC message received from the UE is shown in FIG. 7. The xNB finds the UE context upon receiving the message over SRBx, identifies the Network function ID, and determines specific instance using information from the UE or based on UE's subscription/context.

In order to build the UE specific request for service as in whether the message is to create or modify or some other operation, the UE makes available the service operation in the RRC message outside the NAS container.

The encrypted dedicated distributed NAS message container may be sent within the body of the HTTPS message.

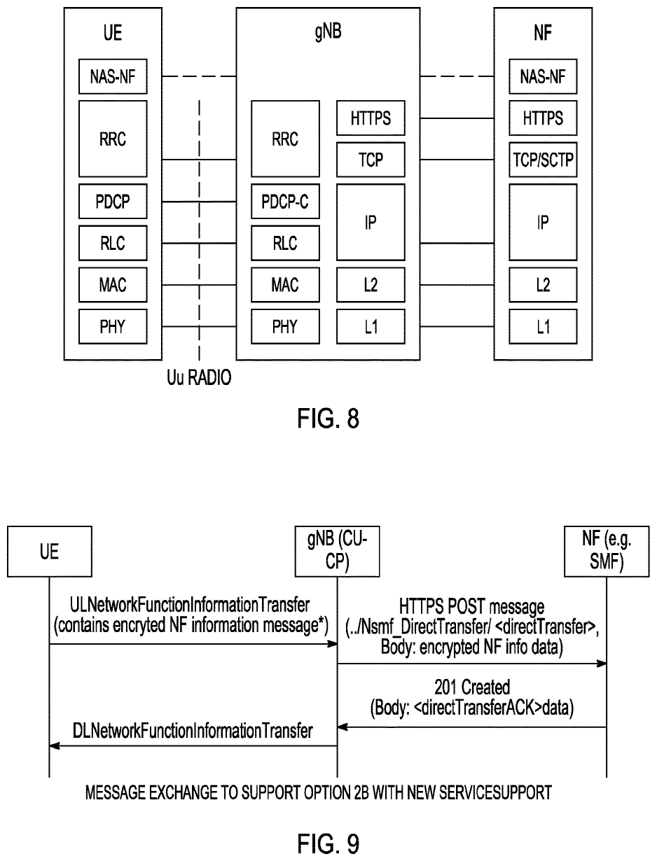

FIG. 8 illustrates another protocol stack in accordance with some embodiments. The protocol stack for this option is shown in FIG. 8, in which the distributed NAS message is end-to-end carrying encrypted information towards the NF while the CU-CP may only be privy to information used to build its HTTPS message.

Option 2b) In this sub-option of option 2, in an example embodiment, the service operation is not visible to the xNB and thus all the message details are transparent to the xNB except for the Network function ID.

The xNB finds the UE context upon receiving the message over SRBx, identifies the Network function ID, and determines specific instance using information from the UE or based on the UE subscription/context.

The xNB then puts together the HTTPS/HTTP post message with a generic service operation for direct transfer and includes the encrypted distributed NAS information in the body of the message.

In this case, the UE may or may not send any request related service operation 4-bit ID for the xNB to identify the request. FIG. 9 illustrates another message exchange in accordance with some embodiments. As shown in FIG. 9, as an example, instead of create or modify, a generic direct_transfer type of service operation is added to all NF service operations. The destination network function may finally decrypt to determine the actual service operation. The xNB essentially merely forwards the request transparently using the SBI (HTTPS).

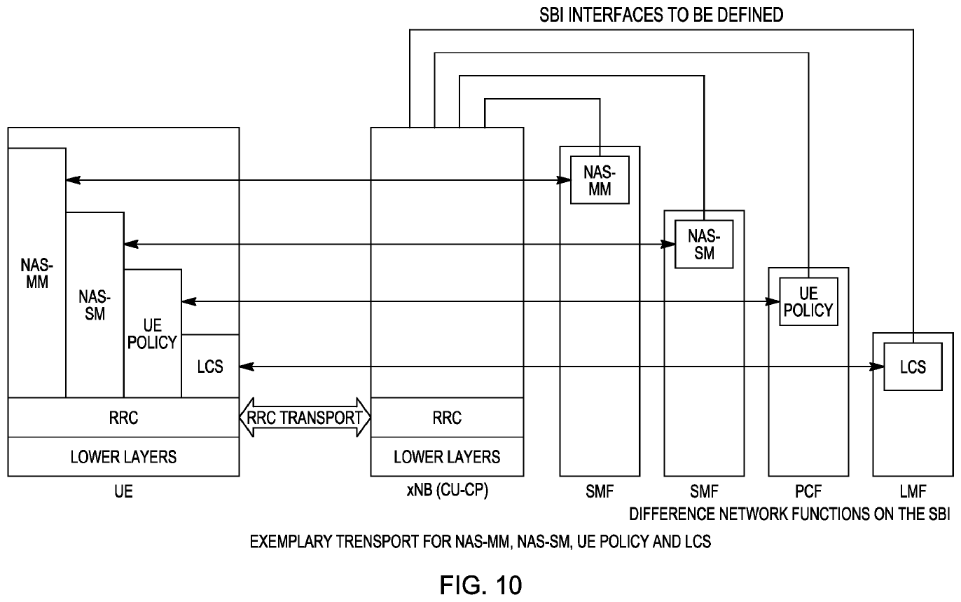

FIG. 10 illustrates transport in accordance with some embodiments. FIG. 10 showcases the example use case of how the CU-CP may be connected to the NFs over the SBI and how the UE uses RRC to transfer the NAS messages in a distributed manner to the different NFs. The RRC transport indicates that the UE may transport the message either only as individual information elements within RRC or a combination of RRC information elements and NAS container within RRC. The transport may be for NAS-MM, NAS-SM, UE policy and LCS.

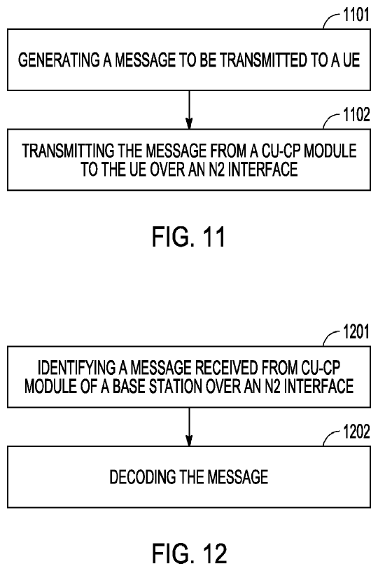

FIG. 11 shows a message process in accordance with some embodiments. The process of FIG. 11 may relate to a method to be performed by a base station, one or more elements of a base station, and/or an electronic device that implements a base station using one of the techniques above. The process may include generating, at 1101, a message to be transmitted to a UE. The process may also include transmitting, at 1102, the message from a CU-CP to the UE over an N₂ interface.

FIG. 12 shows a message process in accordance with some embodiments. The process of FIG. 12 may relate to a method to be performed by a UE using one of the techniques above. The process may include identifying, at 1201, a message to be transmitted to a UE. The process may also include decoding, at 1202, the message.

Enable Distributed NAS between UE and Network Functions in Cellular Networks

As above, in the architecture, the UE may communicate with the NFs through NAS for different purposes including mobility, session management, policies, location based services, etc. through the AMF. The AMF may further direct the messages in the NAS container to other functions such as the SMF, SMSF, PCF, LMF, etc. based on a 4-bit container type, which indicates the destination of the NAS message as shown in Table 9.11.3.40.1 in 3GPP 24.501 (Table 1, above). The AMF resolves the container type and find a NF instance to forward the message.

With cloudification of the network, N2 is going to transform into a SBI so that RAN (i.e., CU-CP) can communicate with other NFs directly via SBIs. However, it is not efficient to have NAS messages going through the AMF. The UE should be able to communicate with different NFs using distributed NAS as shown in FIG. 4. Therefore, enhancements to the CU-CP may permit the CU-CP to identify the type of the distributed NAS message and find a function instance to serve the message.

Various embodiments herein may relate to one or more of the following: the protocol stacks to enable the distributed NAS, the distributed NAS messages between the UE and NF, the routing/processing rules in different entities such as the CU-CP for the distributed NAS, and the mechanism to find a NF instance to serve the UE.

Three options may enable distributed NAS between the UE and NF based on whether the distributed NAS is visible to the CU-CP. Option 1: the CU-CP has full knowledge of the distributed NAS, which can be used to generate a HTTP/HTTPS message using the target NF API of the NF SBI. Option 2: an IE to indicate the NF type and an IE to indicate the NF operation in RRC may enable the CU-CP to generate a HTTP/HTTPS message using the target NF API of the NF SBI. Option 3: Only the IE to indicate the NF type is used to generate a HTTP/HTTPS message with a general service operation newly defined for all NFs.

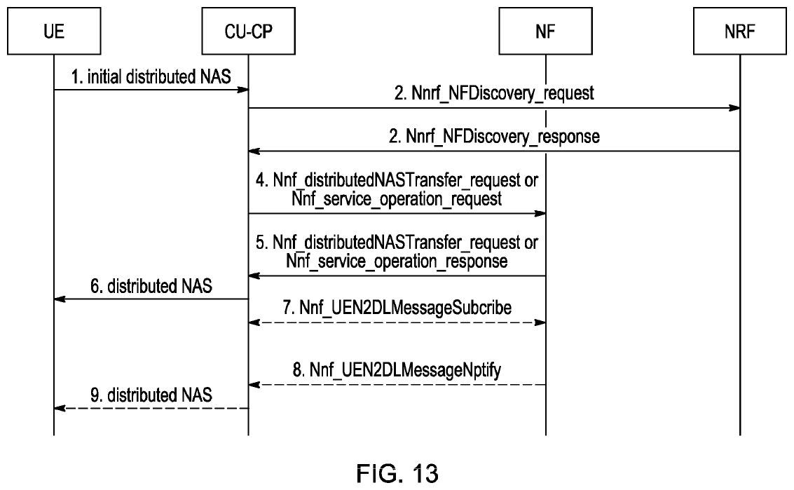

There are different options to decide on a NF instance to serve a UE: a NF instance may be assigned to a UE during the registration procedure and stored as part of UE context information. FIG. 13 shows network function (NF) discovery in accordance with some embodiments. NRF-based NF instance discovery for the distributed NAS between the UE and NF is shown in FIG. 13. When the UE is in the RRC_Connected mode to a CU-CP, the context information can be fetched. In this case, steps 1 and 4-9 of FIG. 13 still apply for the distributed NAS message exchange.

In step 1 of FIG. 13, the UE sends a distributed NAS message targeting a NF such as a SMF, PCF, SMSF, LMF, etc. to the CU-CP.

In step 2, the CU-CP sends a Nnrf_NFDiscovery_request to the NRF to find a NF instance for the UE.

In step 3, the NRF sends a Nnrf_NFDiscovery_response to the CU-CP about the targeted NF instance as defined in 3GPP TS 23.502.

In step 4, the CU-CP receives the distrusted NAS message and generates a HTTP/HTTPS message that includes the information to the targeted NF based on different options described in 5.1.1, 5.1.2 and 5.1.3.

In step 5, the NF sends a HTTP/HTTPS response message to the CU-CP to a targeted UE based on different options described in 5.1.1, 5.1.2 and 5.1.3.

In step 6, the CU-CP sends a distributed NAS message to the UE based on the information from the received response from the NF in Step 3. In optional step 7, the CU-CP may send a

Nnf_UEN2DLMessageSubscribe request to the NF instance discovered in Step 3 for subsequent interactions, such as notifications about a status change or event.

In optional step 8, the NF instance sends a notification Nnf_UEN2DLMessageNotify to the CU-CP about a status change or event.

In optional step 9, the CU-CP may send a distributed NAS message to the UE based on the notification from the NF.

There are three options described herein to enable the distributed NAS between the UE and NFs based on how much information is visible/available for the CU-CP to process the message. Note that there may be different security mechanisms implied based on each option, which may not be described in detail herein.

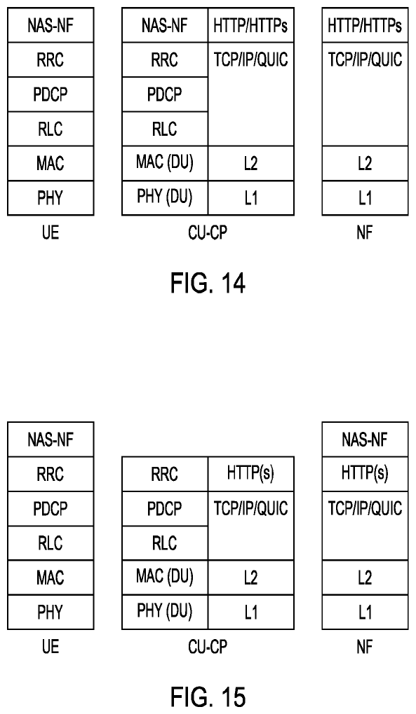

Option 1: the CU-CP has full knowledge of the distributed NAS message. In this option, the NAS-NF (i.e., the distributed NAS) is encrypted between the UE and CU-CP by the PDCP. Therefore, CU-CP has full knowledge of the NAS-NF message which can be used to generate the HTTP/HTTPs message to the NF. FIG. 14 illustrates another protocol stack in accordance with some embodiments. Specifically, FIG. 14 illustrates a Protocol Stack for the CU-CP with full knowledge of the distributed NAS.

To generate the HTTP or HTTPs message in FIG. 13, step 4, the CU-CP decides a URI to reflect the targeted NF service operation as defined in 3GPP TS 23.502. In one example, the CU-CP parses the distributed NAS message from the UE, which includes the UE ID such as a SUPI, the targeted NF in the form of a container type similar to Table 1, the service operation such as a create session context request and related metadata such as session related information (e.g., QoS), the representation of the resource. Then, the CU-CP generates the URI based on service operations and mechanisms as described in 3GPP TS 29.501 using the APIs of the NF.

The construction of the URI follows 3GPP TS 29.501 in the form of
{apiRoot}/<apiName>/<apiVersion>/<apiSpecificResourceUriPart>/<custO pName> where <apiName>, <apiSpecificResourceUriPart> and <custOpName> shall be generated based on the information in FIG. 13, Step 1. Specifically, the <apiName> matches one of the operations defined in clause 5.2 in 3GPP TS 23.502 for each NF.

Option 2: The CU-CP has partial knowledge of the distributed NAS message. FIG. 15 illustrates another protocol stack in accordance with some embodiments. Specifically, FIG. 15 shows a Protocol Stack for a CU-CP with limited knowledge of the distributed NAS. In this option, the distributed NAS is encrypted between the UE and NF, which is transparent to the CU-CP as shown in FIG. 15.

To generate the HTTP or HTTPs message in FIG. 13, Step 2, a new IE may be defined in RRC to indicate the destination of the distributed NAS similar to the 4-bit container type defined in Table 1 in 3GPP 24.501. For example, the IE can indicate the distributed NAS as ‘0001’ for N1 SM information. Additionally, a new IE in RRC may indicate the service operations of the distributed NAS message. For example, the IE may be a 4-bit field to indicate a create session context request. Then, the CU-CP generates the URI similar to Option 1 in 5.1.1. The encrypted distributed NAS message is encapsulated in a HTTP/HTTPS message body.

Option 3: the CU-CP has no knowledge of the distributed NAS message. In this option, the distributed NAS is also encrypted between UE and NF, which is transparent to the CU-CP. The protocol stack is similar to FIG. 15.

To generate the HTTP or HTTPs message in FIG. 13, Step 2, a new IE may be defined in RRC to indicate the destination of the distributed NAS such as a message type similar to the 4-bit container type in Table 1. For example, the IE may indicate the distributed NAS is for ‘0001’ N1 SM information.

New service operations to each NF may be added to all NFs APIs to transfer the distributed NAS from the UE to a target NF. For example, Nnf_distributedNASTransfer_request and Nnf_distributedNASTransfer_response are added to clause 5.2 in TS 23.502. For example, the SMF service operations is similar to Table 2 below.

TABLE 2
SMF service operations with distributedNASTransfer

| | | | Example |
|---|---|---|---|
| | Service | Operation | Consumer |
| Service Name | Operations | Semantics | (s) |
| Nsmf_PDUSession | Create | Request/ | V-SMF/ |
| | | Response | I-SMF |
| | Update | Request/ | V-SMF/ |
| | | Response | I-SMF, |
| | | | H-SMF |
| | Release | Request/ | V-SMF/ |
| | | Response | I-SMF |
| | CreateSMContext | Request/ | AMF |
| | | Response | |
| | UpdateSMContext | Request/ | AMF |
| | | Response | |
| | ReleaseSMContext | Request/ | AMF |
| | | Response | |
| | SMContextStatusNotify | Subscribe/ | AMF |
| | | Notify | |
| | StatusNotify | Subscribe/ | V-SMF/ |
| | | Notify | I-SMF |
| | Context | Request/ | AMF, I- |
| | | Response | SMF, SMF |
| | ContextPush | Request/ | SMF |
| | | Response | |
| Nsmf_EventExposure | Subscribe | Subscribe/ | NEF, |
| | | Notify | AMF |
| | Unsubscribe | | NEF, |
| | | | AMF |
| | Notify | | NEF, |
| | | | AMF |
| | AppRelocationInfo | | AF |
| Nsmf_NIDD | Delivery | Request/ | NEF |
| | | Response | |
| Nsmf_distributedNASTransfer | Delivery | Request/ | CU-CP |
| | | Response | |

The distrusted NAS is encapsulated in the message body of the HTTP/HTTPS message.

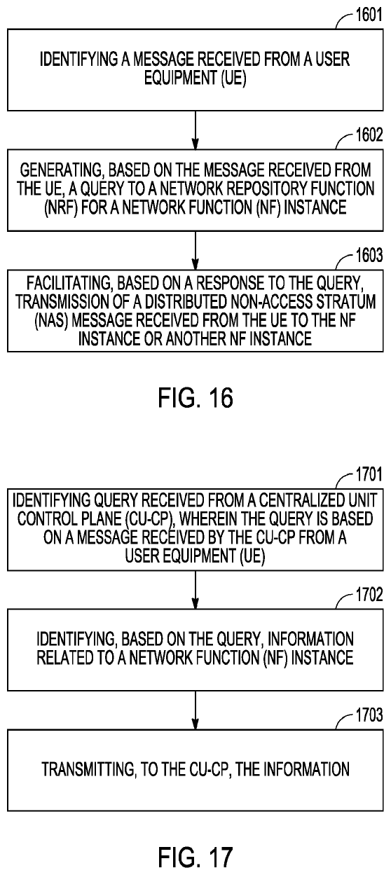

FIG. 16 shows another message process in accordance with some embodiments. The process shown in FIG. 16 may relate to a method to be performed by a CU-CP, one or more elements of a CU-CP, and/or an electronic device that includes or implements a CU-CP. The process may include identifying, at 1601, a message received from a UE; generating, at 1602 based on the message received from the UE, a query to a NRF for a NF instance; and facilitating, at 1603 based on a response to the query, transmission of a distributed NAS message received from the UE to the NF instance or another NF instance.

FIG. 17 shows another message process in accordance with some embodiments. The process may relate to a method to be performed by a NRF, one or more elements of a NRF, and/or an electronic device that includes or implements an NRF. The process may include identifying, at 1701, a query received from a CU-CP, wherein the query is based on a message received by the CU-CP from a UE; identifying, at 1702 based on the query, information related to a NF instance; and transmitting, at 1703 to the CU-CP, the information. In some embodiments the CU-CP is to facilitate, based on the information, transmission of a distributed NAS message received from the UE to the NF instance or another NF instance.

### Enable Service Based Interface Between UE and Network Functions in Cellular Networks

The 6G system is envisioned to integrate communication, computing and data into its scope. In the architecture, UE communicates with NF via NAS protocol through AMF about policy, session management, mobility, etc. For computing, HTTP or similar protocols such as remote process call (RPC), constrained application protocol (CoAP) are widely adopted in cloud computing as it offers easy implementation and metadata/resource description together with other protocols such as JASON, YAML, etc. A service orchestration and chaining function (SOCF) is used to orchestrate a UE computing service and facilitate service discovery, service function chaining (SFC), etc. Therefore, HTTP like protocol is a reasonable candidate for computing related communication between the UE and SOCF. This mechanism may also be extended to any NF.

In legacy specifications, the NAS message is distributed by the AMF to other NFs and the same mechanism does not apply to a HTTP-like protocol directly. Additionally, the routing of HTTP-like messages is generally done by packet filters at the application layer in the cloud computing paradigm, which can be potentially leveraged for the CU-CP and service communication proxy (SCP) in service mesh and configured by service infrastructure control function (SICF).

Embodiments presented herein may relate to one or more of the following: how to enable a SBI between the UE and NF (e.g., SOCF) for an HTTP like protocol; how to route the HTTP message at entities between the UE and NF such as the CU-CP; how to configure HTTP-based filters at the CU-CP for routing; and how to configure eSCP-Cs to route the HTTP message to a NF using service mesh.

Three options enable communication between a UE and a NF instance via a SBI where the UE may be a service consumer or a producer for an NF such as computing services. In Option 1, the CU-CP has visibility to the HTTP message so that HTTP traffic filter is defined to be used for routing. In Option 2, the HTTP message is encrypted between the UE and NF, so the CU-CP may encapsulate the HTTP message between the UE and NF into another HTTP message over N2 or route via IPv6 transport between the CU-CP and a NF instance. In Option 3, a gateway (GW) between the RAN and CN such as an eSCP-C may be used to route the HTTP message. Related CU-CP and NF configurations are also described.

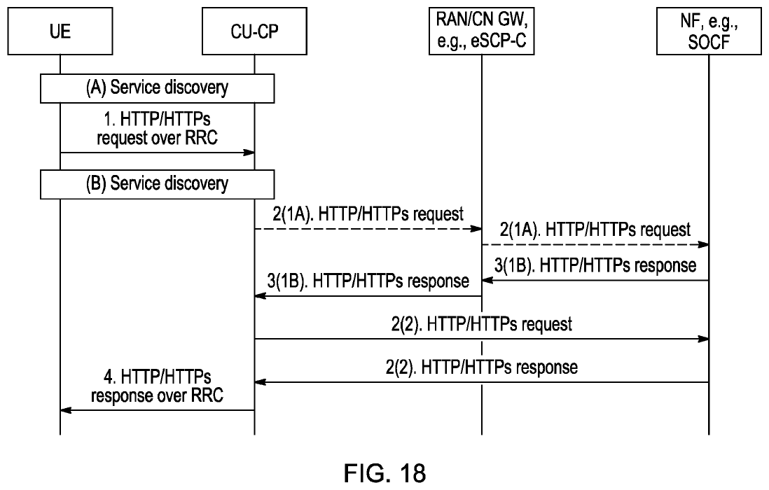

The SBI defined between the UE and NF is bi-directional. Therefore, the UE can consume the NF service or NF can consume the UE service as well. For example, the UE can consume the SOCF for computing service orchestration to offload a computing task to the network. The SOCF can consume the UE computing services and offload a task to the UE with special computing capabilities. FIG. 18 shows a message exchange in accordance with some embodiments. The message exchange for the UE as a consumer is depicted in FIG. 18 between the UE and a NF instance for a HTTP/HTTPS based request/response. The message exchange for UE as a producer can be extended readily based on FIG. 18.
(1) The UE sends a HTTP/HTTPs message via the SBI between the UE and NF that uses RRC as a transport over the air interface to the CU-CP. The service discovery described in (a) of FIG. 18 happens before Step 1) or after Step 1) in (b). The result of the service discovery such as the identifiers about the target NF instances may be stored in the UE or CU-CP or both.

At (1a), the CU-CP may optionally route the HTTP/HTTPS message to a GW between RAN and CN; at (1b) the GW between RAN and CN sends the HTTP/HTTPS message to the target NF instance.
(2) The CU-CP sends the HTTP/HTTPS message to the target NF instance. (1a) The NF optionally sends the HTTP/HTTPS response to the GW between RAN and CN; (1b) The GW optionally sends the HTTP/HTTPS response to the CU-CP.
(3) The CU-CP receives the HTTP/HTTPs response from the target NF instance.
(4) The CU-CP sends the HTTP/HTTPS response over RRC to the UE.

To transport HTTP message, a new container similar to NAS container is defined for RRC in FIG. 18 Step 1 and 4. In addition, a new indicator such as a 1-bit extended field for the 4-bit container type defined in Table 9.11.3.40.1 in 3GPP TS 24.501 is defined to indicate an SBI related protocol such as HTTP is carried in this container visible to RRC. Note: HTTP is used as an example for the SBI related protocols.

There are different options for CU-CP to route the HTTP message as described in 5.1.1-5.1.3 herein.

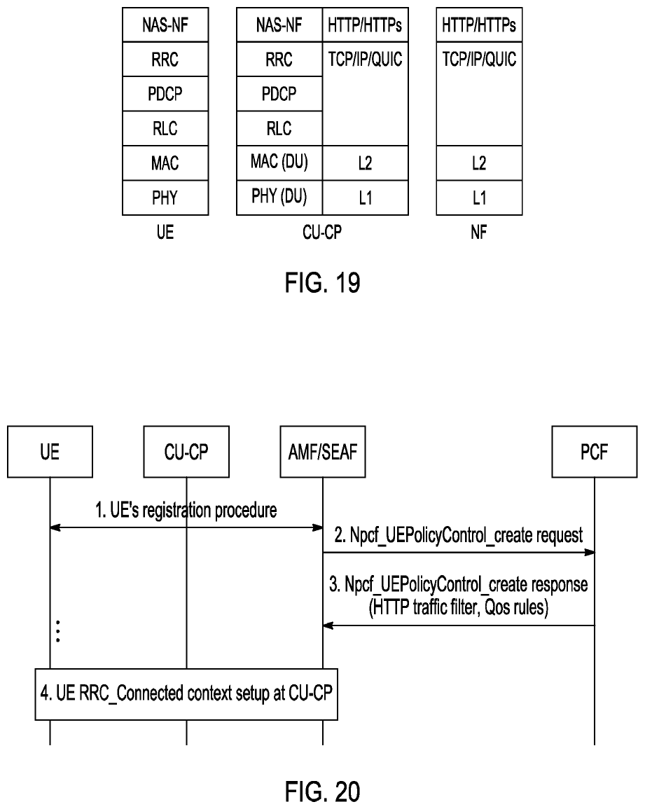

Option 1: HTTP is encrypted by the PDCP between the UE and CU-CP. In this case, the HTTP message is fully visible to the CU-CP. FIG. 19 illustrates a protocol stack in accordance with some embodiments. The protocol stack for option 1 is shown in FIG. 19.

### HTTP Based Traffic Routing Filters/Rules

The routing rules can be based on the HTTP traffic filters configured in the CU-CP on per UE or per NF basis, which includes the following: a target HTTP field such as the URI, HTTP message body, HTTP header or a specific header field or resource representation; a match rule such as key words matching based on SUPI, NF type or NF name; and a routing rule such as route the HTTP message towards a specific NF instance or send the traffic based on load balancing rules to one of the multiple NF instances.

For example, a HTTP filter can include filtering the HTTP message with URI (target field) for “Nsocf” (keyword) and route this message to a SOCF instance that can be a result of service discovery.

For another example, a HTTP filter can include filtering the HTTP message with resource representation (target field) for “JSON” (keyword) and route this message based on the load balancing rule to multiple SOCFs.

For another example, a HTTP filter can include filtering the application ID or S-NSSAI to route the message to a SOCF instance.

In this case, the CU-CP may or may not modify the HTTP message.

For the HTTP message sent from the NF to UE, the CU-CP can decide the destination UE based on the following information: if the HTTP is a response message of a previous request, the CU-CP routes the HTTP message to the UE that sent the request; and if the HTTP message is a request towards a UE, a UE ID such as SUPI, GUTI is included in the HTTP message. For example, /Nue_ComputingService_request/ . . . /compute_resource/UEID/ . . . can be part of the URI in the HTTP message.

FIG. 20 illustrates HTTP traffic filter configuration in accordance with some embodiments. Specifically, the HTTP traffic filter can be configured to the CU-CP as part of the UE context information as shown in FIG. 20. The CU-CP can also enforce HTTP-based QoS rules such as priority, rate limitation, max request per second, etc.
1) UE registration with the cellular network indicating the UE capability for UE and NF SBI, e.g., with a SOCF for computing service.
2) The AMF or SEAF sends a Npcf_UEPolicyControl message to request creating related traffic filter policy.
3) The PCF sends a Npcf_UEPolicyControl response to confirm the result of the policy generation. This UE specific policy can be stored in the AMF/SEAF and UDM.
4) The UE is in RRC_connected state and the CU-CP can download the HTTP traffic policy as part of the UE context information.

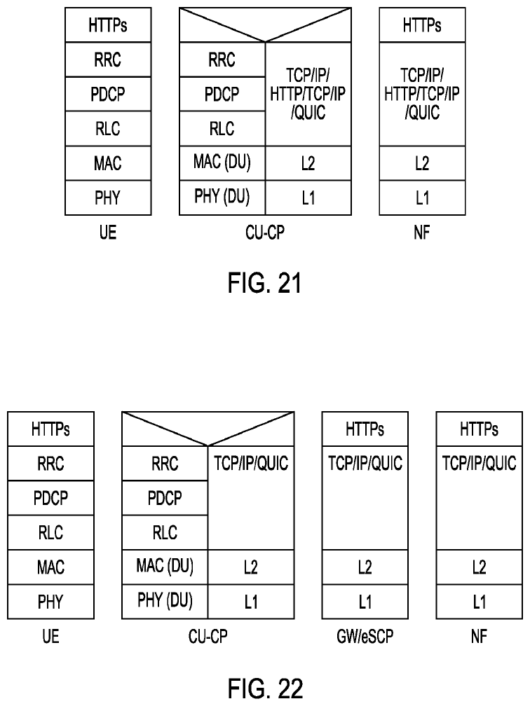

Option 2: the HTTP message is encrypted between the UE and NF. In this case, the HTTP message between the UE and NF is transparent to the CU-CP. FIG. 21 illustrates a protocol stack in accordance with some embodiments. The protocol stack is for a protocol stack for HTTP message encrypted between the UE and NF. When the CU-CP receives the encrypted HTTP message in a RRC container in FIG. 18 Step 1, the CU-CP can:

Option 2.1: encapsulate the HTTP message with a new HTTP header to transfer between the CU-CP and NF via N2 in FIG. 18 Step 2(2). The CU-CP decides the NF type/instance based on the information in RRC similar to the container type in Table 9.11.3.40.1 in 3GPP TS 24.501. A new service operation for message transfer over Nnf (e.g., Nsocf) is defined so that the CU-CP generates a general URI to indicate the operation Nnf_directMessageTransfer. The CU-CP maintains a mapping between the UE ID such as a GUTI or SUPI or SRB ID to the HTTP transaction ID over N2.

Option 2.2: encapsulate the HTTP message with a TCP/IP header. The destination IP address is the selected NF instance IP address, and the source IP address is an IP address assigned to the UE for mapping the IP address to a valid UE ID for the traffic from the NF to the UE. In one example, the IP address is in the form of IPv6 so that the 128 bit can be separated into domain: endpoint name. The domain name is used to identify the CU-CP to which the UE connects, and the endpoint name is used to identify a specific UE. The CU-CP maintains the mapping between an SRB ID or UE ID such as a GUTI or SUPI and the assigned IP address at the CU-CP, which may or may not be used at the UE.

Option 3: HTTP message is encrypted between the UE and a GW. In this case, the HTTP message is transparent to the CU-CP and encrypted between the UE and a GW such as eSCP-C for a service mesh. The GW receives the HTTP message from the CU-CP and sends to a NF instance after decrypting the HTTP message as shown in FIG. 18 Step 2(1) and 3(1). FIG. 22 illustrates a protocol stack in accordance with some embodiments. The protocol stack shown in FIG. 19 is for HTTP encrypted between the UE and a GW. The CU-CP may route the message based on the UE context information. For example, the UE may belong to a specific domain identified by the GW so that the CU-CP routes all the messages towards a domain to a specific GW.

The GW is between the CU-CP and NF has different options:

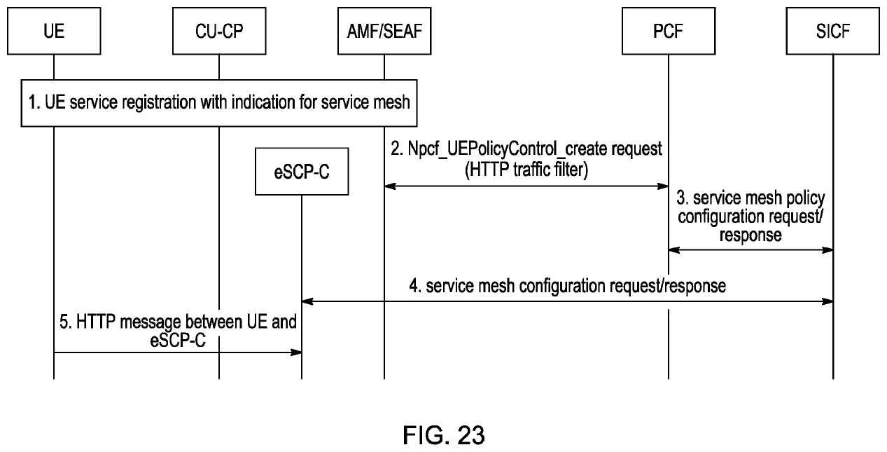

Option 3.1: the GW is an eSCP-C in a service mesh to perform an ingress/egress GW towards a CN. At the eSCP-C, the HTTP traffic filter can be configured similar to the one described in 5.1.1 including a target field, matching rules and routing rules, which can be generated by PCF and configured by SICF. FIG. 23 illustrates an eSCP-C configuration in accordance with some embodiments. Specifically, FIG. 23 illustrates an eSCP-C configuration with an HTTP traffic filter for the UE.

At 1) in FIG. 23, the UE performs registration with the cellular network and indicate its support for service mesh for control plane.

At 2), after authentication and authorization, the AMF requests generation of the UE traffic filter policy, which may be stored as part of the UE context information.

At 3), the PCF may request the SICF configure the eSCP-Cs for a control plane service mesh for the UE.

At 4), the SICF requests to configure the related eSCP-C for the HTTP traffic policy.

At 5), the UE is ready to send encrypted HTTP messages to the eSCP-C through the CU-CP, which is further sent to different NFs.

Option 3.2: the GW may be holding a security context that can be shared by different NFs within the GW domain to reduce separate security context for a NF. In this case, the GW can route the HTTP message toward different NFs based on the traffic filter described in 5.1.1 after decrypting the HTTP message.

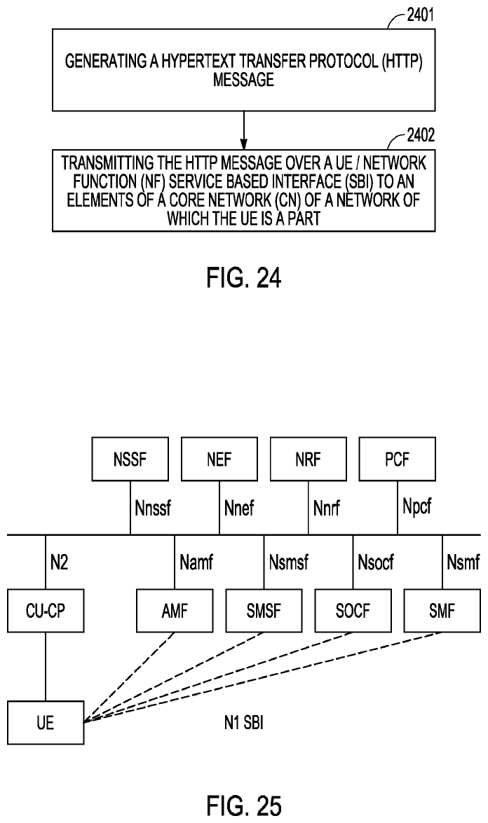

FIG. 24 shows a message process in accordance with some embodiments. The process may relate to a method to be performed by a UE, one or more elements of a UE, and/or an electronic device that includes or implements a UE. The process may include generating, at 2401, a HTTP message; and transmitting, at 2402, the HTTP message over a UE/NF SBI to an elements of a CN of a network of which the UE is a part. In some embodiments, the HTTP message is encrypted between at least the UE and another point of a transmission path between the UE and the CN.

Support of UE Communication to Control Plane Network Functions with N1 and N2 SBI in Service-Based Architecture

As above, the UE sends NAS messages through the gNB towards the AMF. FIG. 25 illustrates a UE to network SBI-based solution in accordance with some embodiments. FIG. 25 showcases the high level architecture wherein both the CU-CP and UE are supportive of Service Based Interface (N1 and N2).

In one embodiment, the UE can reach the network functions via the SBI (i.e., N1 is SBI) towards each of the interested NF. Note that the gNB/RAN is already on the SBI such that the gNB/CU-CP may act as the relay for the UE towards the rest of the functions on the SBI including the AMF. Considering the architecture as shown in FIG. 25, the NF service can be reached by the UE as discussed further below. Note that the UE has exchanged its capability with the network to determine the support of any of the following options (to forward microservice request in this manner) from both UE and network perspective.

The UE receives RRCReconfiguration for configuration of the PHY/MAC/RLC/PDCP related to the signaling radio bearer used for the transport over the air or may use a default configuration.

The gNB indicates support of the SBI functionality via broadcast signaling (e.g., system information).

In another example, the NF ID of the assigned NF instance may be directly configured to the UE. This information may be provided at registration based on the UE subscription by the AMF (or similar function to be considered in 6G) and/or at RRC Reconfiguration by the xNB/CU-CP.

In another example, the UE performs service discovery or another method and is aware of the IP addresses or the NF ID (i.e., unique identifier of the NF, NF type or FQDN) of the different network functions as well as the gateway node (e.g., AMF, API GW or ingress/egress GW).

In some cases, the gNB is assumed to query the NRF to obtain the IP address of the different NFs if the UE only provided a related ID such as NF ID, NF type, FQDN, etc.

The different solution options provided below enable the transport of the UE message towards different NFs as described below. All of the information details are applicable to both legacy services and new services such compute supporting functions with corresponding service operations.

During the initial registration procedure, the UE obtains the identifier of the network function [e.g., SMF] and stores this identity information for different network functions. It is understood that the UE may perform registration using a procedure via the AMF like function.

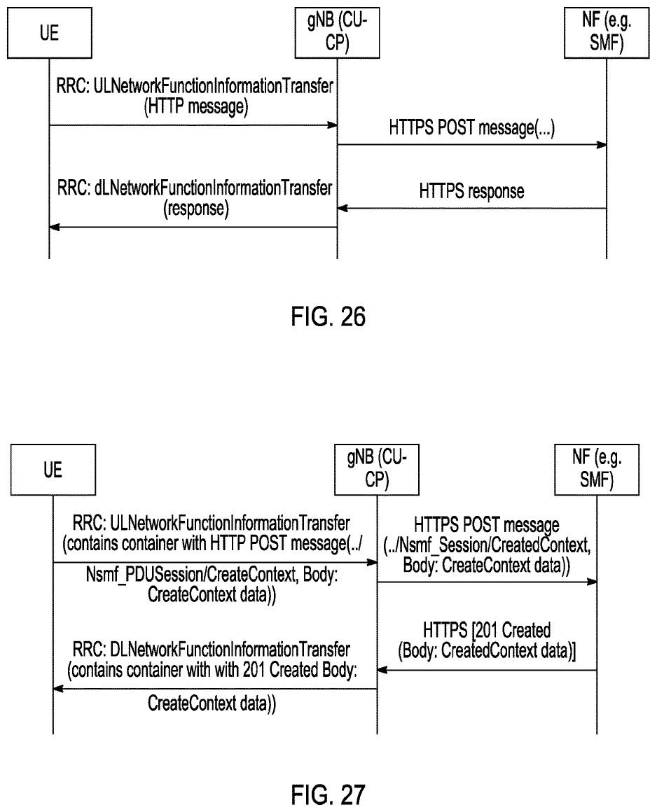

FIG. 26 illustrates an UL/DL RRC message for UE N1 SBI information transfer in accordance with some embodiments. Once in RRC connected mode after registration, a newly defined RRC message that includes the network function identifier and the message contents for the xNB/CU-CP to utilize to build a HTTPS message and forward towards the required network function (using the HTTP message from the UE), is shown in FIG. 26. The UE sends a generic RRC message similar to ULInformationTransfer already defined, however, the contents of the new message are different and discussed below in the different options. An example option is shown here where the UE communicates with the SMF.

An example use case of PDU session establishment and request for creation of session context data at the SMF is shown for the sake of description of embodiments herein. The example can be extended to support other services with other network functions in a similar fashion including with new network functions to support compute service/resource access.

Option 1) Using RRC message for transfer of HTTP-based message/protocol: during initial registration procedure, the UE obtains the identifier of the network function [e.g., SMF] or microservice for a service mesh scenario (or upon service discovery for non-service mesh scenario) and stores this identity information for different network functions. Note that HTTP is an example protocol for a SBI implementation. Alternative protocols such as constrained application protocol (COAP), remote process call (RPC) may be used.

FIG. 27 illustrates an UL/DL RRC message for UE N1 SBI information transfer for a PDU session in accordance with some embodiments. Once in connected mode, a newly defined RRC message that includes the network function identifier and the message contents for the gNB/CU-CP to utilize and forward directly towards the network function by using the HTTP message from the UE, is considered as shown in FIG. 27.

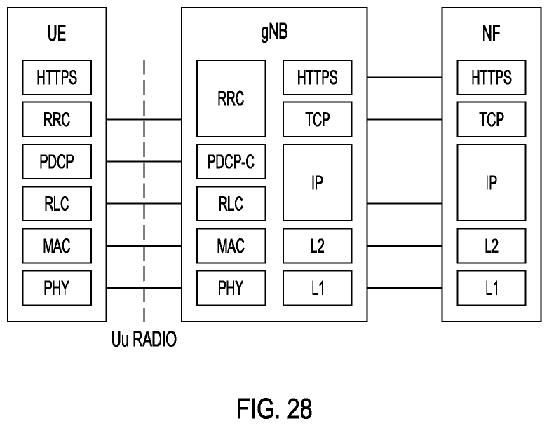

FIG. 28 illustrates a protocol stack in accordance with some embodiments. The protocol stack from FIG. 28 showcases that the UE gets the HTTP message from upper layer and the control plane RRC is used as transport to send the message towards the gNB using AS security. The gNB then establishes another HTTP/HTTPS session with the NF to send the request based on the information from the RRC control message received from the UE.

RRC message details: a new message over an existing or new SRB (e.g., UL/DL DCCH message). In another example, a new type of radio bearer such as Microservice Radio bearer (MRB) may be defined to carry this message over the air towards the CU-CP via the DU.

Contents of the RRC message: sent as individual IEs (these are example elements): UE ID (e.g., assumed as core network value such as ng-5G-S-TMSI or 5G-GUTI or SUPI, but can be a newly defined UE ID that is visible to the SBA i.e., both RAN and CN). NF identification can include all or a combination of the following (protocol discriminator): a) 4-bit NF message type ID referring to the payload container type (Note: 4 bits is exemplary and may be set to ‘n’ bits); b) NF type (AMF, SMF, SMSF, PCF . . . ) if desired (if NF ID is provided, this may not be used). It is possible for the UE to have only one UL RRC message and only one DL RRC message defined to support transaction to every NF (the IEs encompass all the different aspects of the NFs) or multiple UL/DL RRC messages defined corresponding to each NF or a group of NFs. For the sake of description of embodiments herein, the former is showcased, in which the NF type specifies the type of NAS message aimed towards a specific NF. The contents of the message may vary depending on the NF the UE is trying to reach; and c) NF ID as unique identifier or IP address or FQDN [similar to UE requested DNN]. Sent within a container is the body of the HTTP message (shown here as an example for PDU session context creation at the SMF for a PDU session): UE ID (referring to the context at the NF or core network); Slice ID; Session ID if applicable; Old session ID if applicable; Request type (initial request, existing session . . . ) if applicable; and Request (Session establishment request, Session modification request . . . ) for 4-bit for service operation.

Since this option is RRC based, it is terminated at the gNB (CU-CP) PDCP layer (with encryption at PDCP level).

Message details are visible to the gNB (i.e., not transparent) and depending on the option, the HTTP message is visible or not visible.

### ULNetworkFunctionInformationTransfer

The ULNetworkFunctionInformationTransfer message is used for the uplink transfer of network function related information/request.

Signaling radio bearer: SRBx or SRB2. If SRBx is suspended, the UE does not send this message until SRBx is resumed. RLC-SAP: AM, Logical channel: DCCH, Direction: UE to network.

### ULNetworkFunctionInformationTransfer Message (Option 1)

-- ASN1START
-- TAG-ULINFORMATIONTRANSFER-START
ULNetworkFunctionInformationTransfer::=

| | |
|---|---|
| criticalExtensions | CHOICE { |

ULNetworkFunctionInformationTransfer
ULNetworkFunctionInformationTransfer-IEs,

| | |
|---|---|
| criticalExtensionsFuture | SEQUENCE { } |

}
}

| | |
|---|---|
| ULNetworkFunctionInformationTransfer-IEs ::= | SEQUENCE { |

| | |
|---|---|
| selectedPLMN-Identity | INTEGER (1..maxPLMN), |
| registeredAMF | RegisteredAMF |

OPTIONAL,

| | |
|---|---|
| guami-Type | ENUMERATED {native, mapped} |

OPTIONAL,

| | |
|---|---|
| s-NSSAI-List | SEQUENCE (SIZE (1..maxNrofS-NSSAI)) OF |

S-NSSAI OPTIONAL,

| ng-6G-S-TMSI-Value | CHOICE { | |
|---|---|---|
| ng-6G-S-TMSI | NG-6G-S-TMSI, | |
| ng-6G-S-TMSI-Part2 | BIT STRING (SIZE (9)) | |
| } | | OPTIONAL, |

| | |
|---|---|
| networkFunctionMessageType-r19 | OCTET STRING (SIZE (4)), |

OPTIONAL,

| | |
|---|---|
| networkFunctionId-r19 | OCTET STRING (SIZE (8)), |

OPTIONAL,

| | |
|---|---|
| networkFunctionNode-r19 | ENUMERATED {AMF, SMF, SMSF, |
| | SOCF, spare, spare, spare, spare, spare |
| | spare, spare}, |
| | OPTIONAL, |
| serviceName | OCTET STRING (SIZE(4)), |
| | OPTIONAL, |
| requestType | ENUMERATED {initial, existing}, |

OPTIONAL,

| requestOperation | ENUMERATED {create, modify, | |
|---|---|---|
| | release, spare, spare, spare, spare, | |
| | spare}, | OPTIONAL, |

| | |
|---|---|
| networkFunctionContainer-r19 | OCTET STRING( ), |

```
      OPTIONAL,
    ....
    ....
    ....
```

| | | |
|---|---|---|
| lateNonCriticalExtension | OCTET STRING | OPTIONAL, |
| nonCriticalExtension | SEQUENCE { } | OPTIONAL |

}
-- TAG-ULINFORMATIONTRANSFER-STOP
-- ASN1STOP

The UE ID can be same as the one defined in a core network or modified to accommodate the corresponding area within which the ID is applicable/visible. As per TS 38.331 (and TS 23.003), the S-NSSAI identifies the network slice and comprises of the slice/service type and slice differentiator as shown below.

| -- ASN1START | |
|---|---|
| -- TAG-S-NSSAI-START | |
| S-NSSAI ::= | CHOICE{ |
| sst | BIT STRING (SIZE (8)), |
| sst-SD | BIT STRING (SIZE (32)) |

-- TAG-S-NSSAI-STOP
-- ASN1STOP

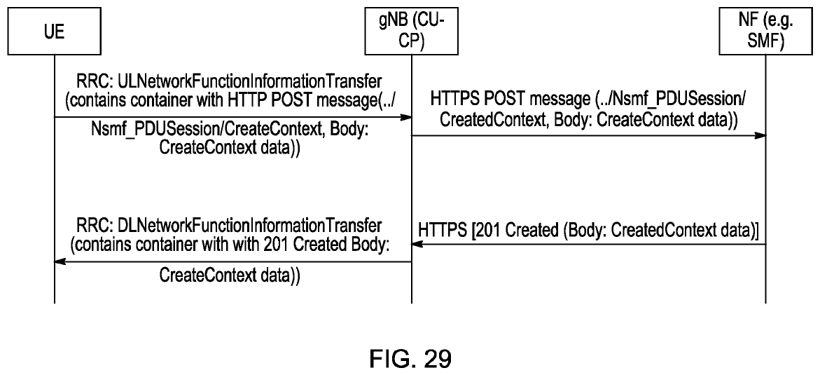

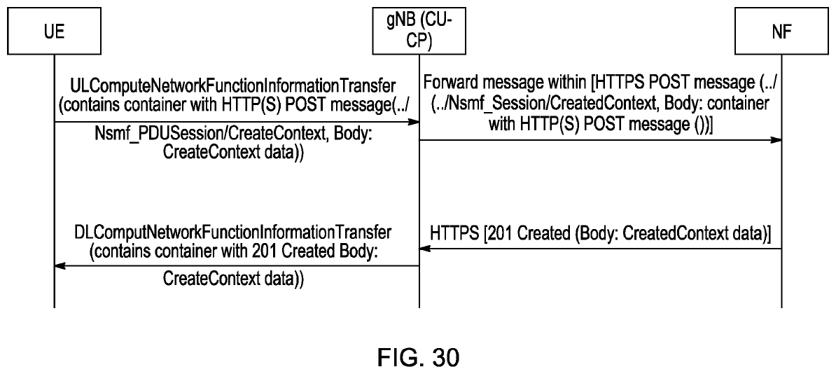

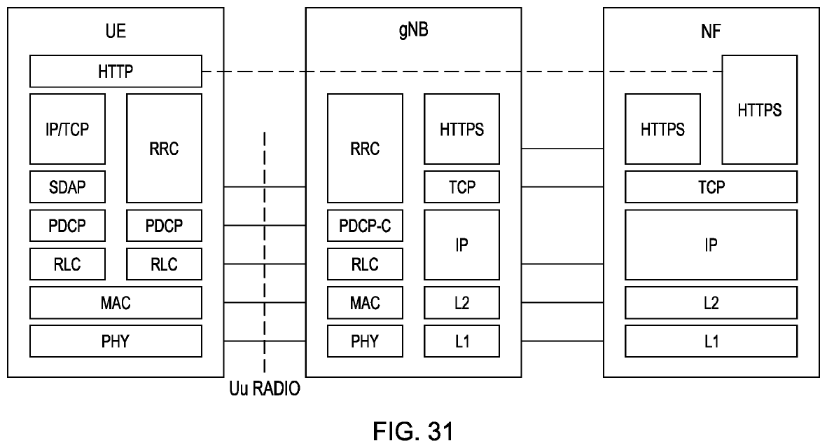

FIG. 29 illustrates an UL/DL compute information transfer in accordance with some embodiments. FIG. 30 illustrates an UL/DL compute information transfer in accordance with some embodiments.

The message can contain either of the two options below:
1a) The HTTP message from the UE is used by the gNB to put together its own HTTPS message. This is shown in FIG. 29.
1b) The HTTP message from the UE encapsulated as is within the body of the HTTPS message. This is shown in FIG. 30.

In both the options, a combination of the message type (payload container type), the service name (e.g., Nsmf_PDUSession), service operation and request types along with NF identifier are made available as desired within the RRC message outside of the UE SBI (HTTP) message. The information elements are provided as exemplary and can be used in any combination or format of data type along with different exact names to represent the same element. In one example, as shown in FIG. 29, the contents of the UE SBI message (using HTTP protocol) are visible to the gNB in option 1a.

In another embodiment, as shown in FIG. 30, the SBI (using HTTP protocol) message from the UE is transparent to the xNB and encapsulated within the body of another HTTPS message from the CU-CP to the NF in option 1b. The NF identifier and the service operation may be visible to the CU-CP from the RRC message, and the rest is sent as encrypted end-to-end between the UE and the NF. FIG. 31 illustrates a protocol stack in accordance with some embodiments. The protocol stack corresponding to option 1b is shown in FIG. 31, in which the HTTP(S) association is between the UE and the NF.

Option 1c) In this sub-option of option 1, all the message details are transparent to the gNB except for the Network function ID.

The gNB finds the UE context upon receiving the message over SRBx, identifies the Network function ID and determines specific instance using information from the UE or based on the UE subscription/context.

The gNB then puts together the HTTPS/HTTP post message with a generic service operation for direct transfer and includes the encrypted distributed NAS information in the body of the message.

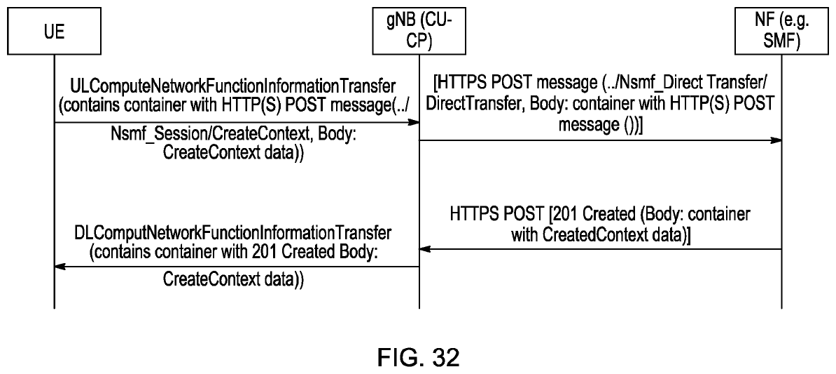

In this case, the UE may or may not send any request related service operation 4-bit ID for the gNB to identify the UE. FIG. 32 illustrates an UL/DL compute information transfer in accordance with some embodiments. As shown in FIG. 32, as an example, instead of create or modify, a generic direct_transfer type of service operation may be considered. The destination network function can finally decrypt to determine the actual service operation. The gNB essentially merely forwards the request transparently. The SBI message from the UE contains the actual service name and operations for the NF while the HTTPS message from CU-CP to the NF contains a generic service name and operation e.g. Nnf_DirectTransfer(CreateDirectTransfer).

Option 2) Using an HTTP message with a gateway in-between the CU-CP and the destination NF: In another embodiment, there is a gateway between the gNB (CU-CP) and the network function. The UE establishes an end-to-end HTTPS connection/SBI with only the gateway (e.g., AMF). The gateway ID may be available at the UE and is provided to the gNB. The gNB then forwards the message to the gateway and the gateway uses the UE ID and thereafter forwards the message to the corresponding network function.

The contents of the HTTP message encapsulated in a container within the RRC between the UE and gNB can be summarized as per below:

RRC message details: a new message over existing or new SRB (e.g., UL/DL DCCH message). In another example, a new type of radio bearer such as MRB may be defined to carry this message over the air towards the CU-CP via the DU.

Contents of the RRC message: sent as individual IEs (these are exemplary elements): UE ID (e.g., assumed as core network value such as ng-5G-S-TMSI, but it can be a newly defined UE ID that is visible to the SBA i.e., both RAN and CN); NF type (AMF, SMF, SMSF, SOCF . . . ); Gateway identification if available; NF identification can include all or a combination of the following (protocol discriminator): a) 4-bit NF message type ID referring to the payload container type (Note: 4 bits is exemplary, it can be set to ‘n’ bits); b) NF type (AMF, SMF, SMSF, PCF . . . ) if desired (if NF ID is provided, this may not be used). It is possible for the UE to have only one UL RRC message and only one DL RRC message defined to support transaction to every NF (the IEs should encompass all the different aspects of the NFs) or multiple UL/DL RRC messages defined corresponding to each NF or a group of NFs. In descriptions of embodiments herein, the former is showcased in which the NF type specifies the type of NAS message aimed towards a specific NF. The contents of the message could vary depending on the NF the UE is trying to reach; and c) NF ID as unique identifier or IP address or FQDN [similar to UE requested DNN]. The RRC message is sent within the body of the HTTP message (if visible to the gNB or outside as RRC IEs if the HTTP message is not visible to the gNB): UE ID (referring to the context at the NF or core network); Slice ID; Session ID if applicable; Old session ID if applicable; Request type (initial request, existing session . . . ) if applicable; and Request (Session establishment request, Session modification request . . . ) for 4-bit for service operation.

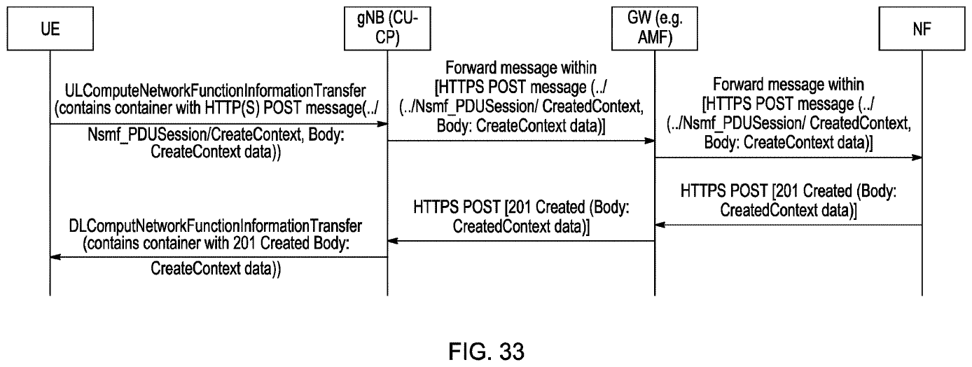

FIG. 33 illustrates UL/DL information transfer using a gateway in accordance with some embodiments. FIG. 33 shows the message exchange between the UE and RAN and the GW and NF. An example case of how the gNB (or xNB for 6G) builds the HTTPS POST message based on the RRC message received from the UE is shown in FIG. 33. The gNB finds the UE context upon receiving the message over SRBx, identifies the gateway that is assigned for the UE and forwards the HTTPS message towards the GW.

The GW further finds the UE context, then the Network function ID and determines specific instance using information from the UE or based on the UE subscription/context.

In order to build the UE specific request for service as in whether the message is to create or modify or some other operation, the UE has makes available the service operation in the RRC message outside the HTTP message if the message is not visible to the gNB.

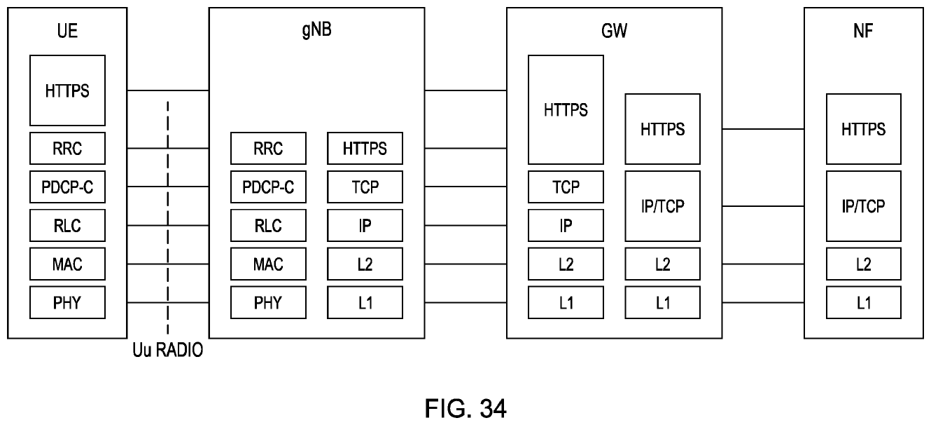

FIG. 34 illustrates a protocol stack in accordance with some embodiments. The protocol stack for this option is shown for the case in which the UE has end-to-end SBI operation with the gateway.

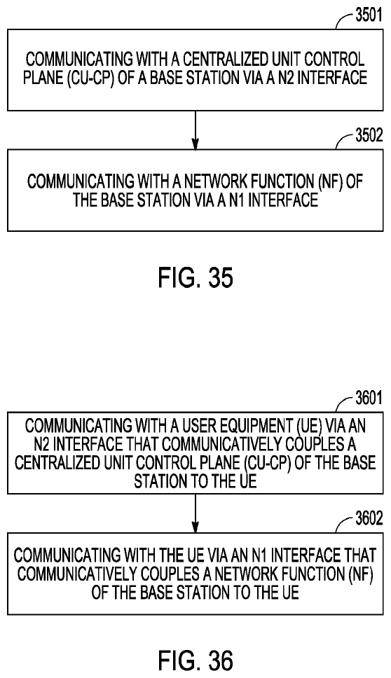

FIG. 35 shows a message process in accordance with some embodiments. The process FIG. 35 may relate to a method to be performed by a UE, one or more elements of a UE, and/or an electronic device that includes or implements a UE. The process may include communicating, at 3501, with a CU-CP of a base station via a N2 interface; and communicating, at 3502, with a NF of the base station via a N1 interface.

FIG. 36 shows a message process in accordance with some embodiments. The process of FIG. 36 may relate to a method to be performed by a base station, one or more elements of a base station, and/or an electronic device that includes or implements a base station. The process may include communicating, at 3601, with a UE via an N2 interface that communicatively couples a CU-CP of the base station to the UE; and communicating, at 3602, with the UE via an N1 interface that communicatively couples a NF of the base station to the UE.

Disaggregation with Enhanced Distributed Unit to Support Flexible User Plane Functions

As above, a gNB may include a gNB-CU-CP, multiple gNB-CU-Ups, and multiple gNB-DUs. One gNB-DU is connected to only one gNB-CU-CP; one gNB-DU may be connected to multiple gNB-CU-UPs under the control of the same gNB-CU-CP; and one gNB-CU-UP may be connected to multiple DUs under the control of the same gNB-CU-CP. The connectivity between a gNB-CU-UP and a gNB-DU is established by the gNB-CU-CP using Bearer Context Management functions. The gNB-CU-CP selects the appropriate gNB-CU-UP(s) for the requested services for the UE. When multiple CU-UPs are present, the CU-UPs belong to same security domain as defined in TS 33.210 [TS 38.401]. In order to support local breakouts and compute intensive traffic, it is beneficial for the UE to be allowed to communicate with multiple CU-UPs distributed across the network, including a user plane entity at the DU level. Embodiments herein relate to how one UE may be configured to exchange control plane configuration information directly with the DU or enhanced DU (eDU) and communicate via multiple user plane network entities (e.g., located with the DU) explicitly to perform compute and communication efficiently. Specifically, embodiments may include details of an example enhanced distributed unit (eDU) to support multiple distributed user plane entities and corresponding UP configuration for a given UE.

The architecture in FIG. 1C corresponds to the non-roaming system architecture [TS 23.501] in which the AMF is the single source of entry for the control plane and the RAN (gNB) has an N2 interface towards the core network (with the AMF as the entry point). The UE sends NAS messages through the gNB towards the AMF. The RAN is considered to be disaggregated into the DU and CU and the overall architecture of the separation of the CU into CU-UP and CU-CP is shown in FIG. 1C.

As per TS 38.401, the following rules apply to the RAN split architecture: a gNB may include a gNB-CU-CP, multiple gNB-CU-UPs, and multiple gNB-DUs; the gNB-CU-CP is connected to the gNB-DU through the F1-C interface; the gNB-CU-UP is connected to the gNB-DU through the F1-U interface; the gNB-CU-UP is connected to the gNB-CU-CP through the E1 interface; one gNB-DU is connected to only one gNB-CU-CP; one gNB-CU-UP is connected to only one gNB-CU-CP (for resiliency, a gNB-DU and/or a gNB-CU-UP may be connected to multiple gNB-CU-CPs by appropriate implementation); one gNB-DU can be connected to multiple gNB-CU-UPs under the control of the same gNB-CU-CP; and one gNB-CU-UP can be connected to multiple DUs under the control of the same gNB-CU-CP. The connectivity between a gNB-CU-UP and a gNB-DU is established by the gNB-CU-CP using Bearer Context Management functions. The gNB-CU-CP selects the appropriate gNB-CU-UP(s) for the requested services for the UE. In case of multiple CU-UPs they belong to same security domain as defined in TS 33.210. Data forwarding between gNB-CU-UPs during intra-gNB-CU-CP handover within a gNB may be supported by Xn-U.

Embodiments herein relate to the disaggregation of the gNB-DU or xNB Distributed Unit to enable new types of services to be supported (at local cell sites or closer to RAN edge) alongside the legacy data connection to the DN via CU-UP and UPF.

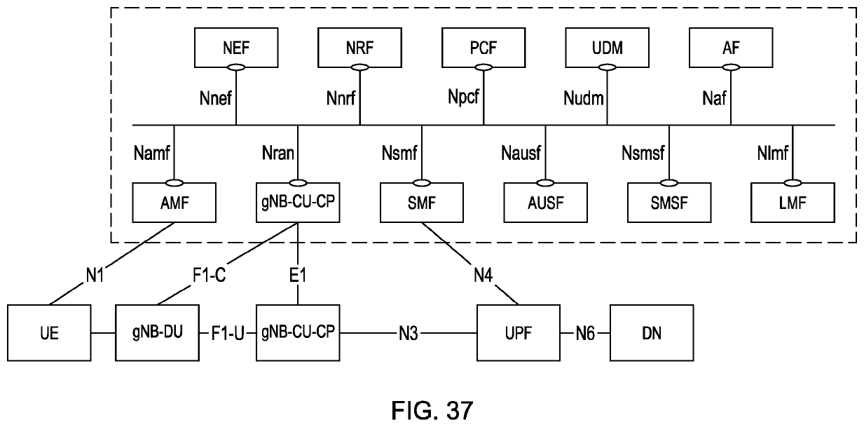

FIG. 37 illustrates a high-level architecture with RAN disaggregation in accordance with some embodiments. As shown in FIG. 37, the RAN includes a DU and CU, and the CU-CP is on the SBI. As per legacy specifications, the CU-CP selects the CU-UP based on the services to be used by the UE and, in case of multiple CU-UPs, the CU-CP and CU-UP belong to the same security domain, i.e., the CU-CP is transparent to the UE. The CU-CP may assign some bearers to one CU-UP and some other bearers to another CU-UP all without the knowledge of the UE and manages the connections internal to the gNB implementation.

### Architecture Using eDU

Multiple architecture options are possible for a flexible/scalable and distributed/modular architecture to enable truly distributed user plane functionality in which configuration of the CU-UP is performed locally (modular).

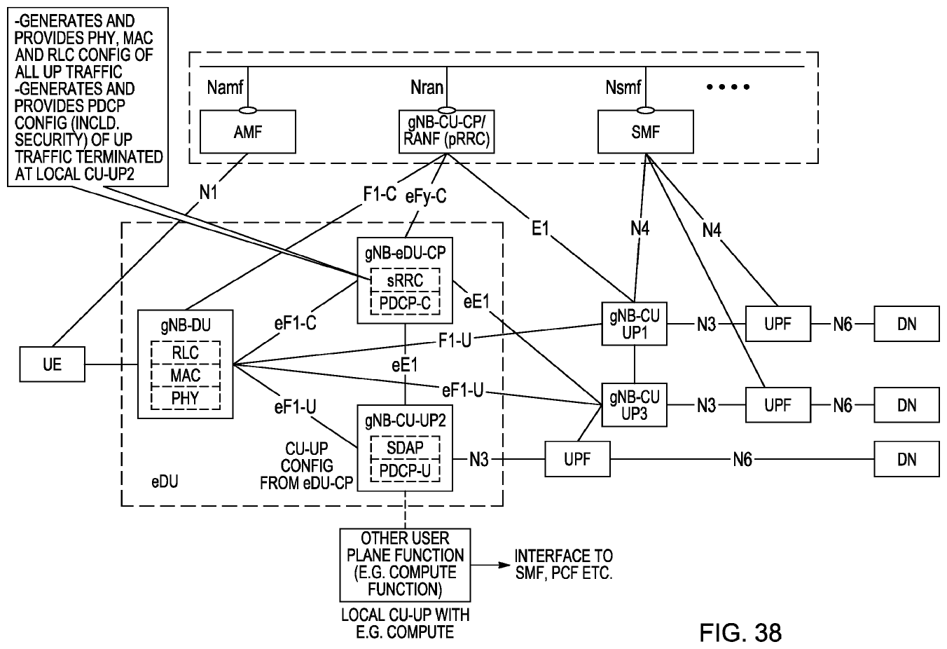

Option a) eDU with local CU-UP and legacy CU-UP. FIG. 38 illustrates RAN disaggregation with eDU support in accordance with some embodiments.

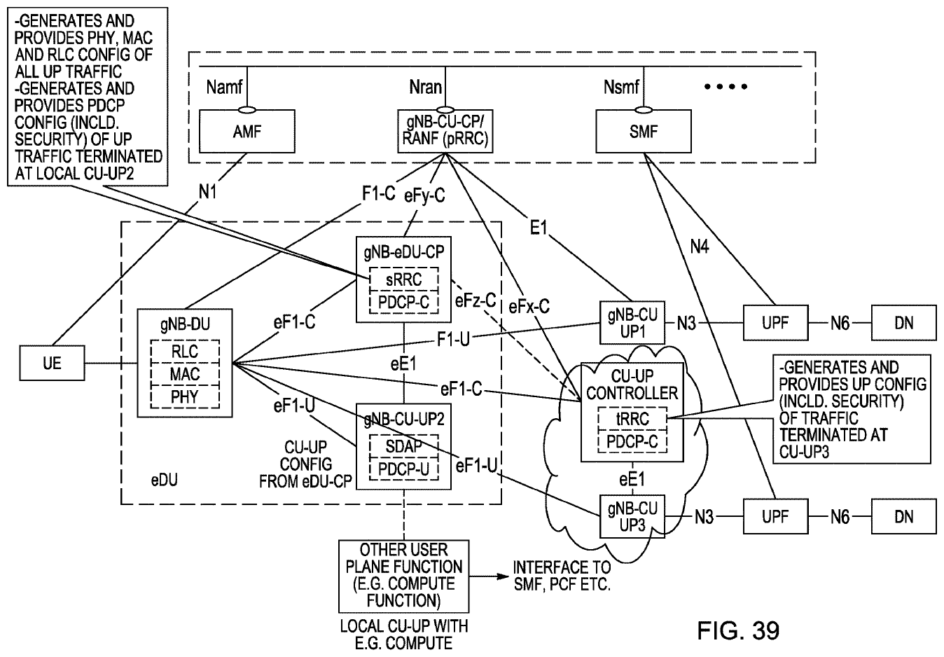

Option b) eDU with local CU-UP, legacy CU-UP and distributed CU-UPs with individualized controller. FIG. 39 illustrates RAN disaggregation with eDU support and separate CU-UP in accordance with some embodiments.

FIG. 38 depicts an example architecture of further RAN disaggregation in which the DU is enhanced to an eDU to include support of the role of a CU-UP as in CU-UP2/eDU-UP for local user plane handling as well as an eDU-CP for providing related lower layer and corresponding user plane configuration. That is, the eDU-CP supports PDCP and RRC (i.e., secondary RRC) with the eDU-UP/CU-UP2 supporting PDCP and SDAP layers for user plane e.g., towards the UPF or local compute function. The PDCP allows for a security function at the eDU for handling of user plane packets locally.

This uses a common PHY/MAC of the DU and provides local breakout functionality at the cell site for specific services.

In this example deployment, support of control plane functions via a secondary RRC (sRRC) at the eDU may work together with a primary RRC (pRRC) at the CU-CP/RANF function on the SBI.

There may be an overlap of functions performed at the CU-CP and eDU-CP, however, one goal is to perform the functions closer to the UE to reduce signaling latency—for example, RRCReconfiguration of lower layers and Radio bearers supported at the eDU itself, and user plane function, CU-UPx @eDU.

As shown in FIG. 38, the eDU may also provide access to the UPF/DN connection either via its own stack or through the legacy DU-CU-UP route. FIG. 38 depicts only a local user plane function, e.g., compute or other user plane function supported at the eDU and may terminate further towards policy and charging function as desired. Furthermore, embodiments depict that the eDU supports both an interface to a local UP function as well as connectivity to the data network via the UPF through CU-UP2 as well as CU-UP3. As shown, CU-UP2 is located at the cell site, whereas CU-UP3 may be distributed in the cloud.

The UE may have services/bearers utilizing the enhanced DU located closer in proximity while other services follow legacy and connect to the UPF/DN via the CU-UP disposed at a different location. This helps to reduce the UE access latency through such local breakout possibilities.

The architecture thus supports distributed handling of traffic/services in a manner using multiple CU-UPs/eDU-UPs accordingly. The configuration for these entities can therefore be handled individually.

In another example, the distributed control can be extended further to support a local controller (CU-UP controller) for the configuration of the CU-UP nodes, as shown in FIG. 39. The CU-UP controller may perform local configuration of the CU-UP associated with the controller. For example, the CU-UP controller may set up a new DRB in the associated CU-UP, also coordinating with the eDU-CP controller to set up the lower layers of the DRB or modify an existing DRB for the protocol layers that reside in the CU-UP. The CU-UP also provides the corresponding configuration to the UE. This signaling to the UE may take one of many possible paths—either directly interfacing with the gNB-DU and communicating with the UE over a separate logical channel or being tunneled by the eDU-CP encapsulated in the secRRC. The CU-UP controller may obtain authorization from the CU-CP along with additional configuration restrictions. The CU-UP controller may also negotiate the configuration restrictions with the CU-CP if desired. The CU-CP coordinates across all the CU-UP controllers of the UE to ensure the UE subscription policies and UE capabilities are not exceeded. Signaling from each CU-UP controller may be secured (encrypted/integrity protected) locally, for example, using a local PDCP entity specific for this or may use the security functions located in the associated CU-UP or depend on the security function used by the eDU-CP secRRC.

Thus, benefits of the above architecture can be outlined as follows: easy local breakouts, including at the DU; scalable in terms of number of Ups; the CU-CP functions are similar to the AMF, thereby allowing easier integration (if so desired) and scalable joint move to service based functions (i.e., RANF on the SBI); providing a PHY/MAC/RLC configuration directly from the DU to UE, thereby reducing delay and network signaling; and local control plane functions with, e.g., secondary/tertiary RRC, further reducing configuration delay.

### New Interfaces

Embodiments may define certain new interfaces (with temporary interface names) to connect the new nodes to the legacy nodes to provide data access to the UE. The interfaces include: eDU-CP and CU-UPx is referred to as the eE1 interface; DU lower layers and eDU-CP is referred to as the eF1-C interface and the DU to local or those CU-UP(s) controlled by eDU-CP, referred to as the eF1-U interface (whereas the legacy DU to CU-UP interface is referred to as the F1-U interface); distributed CU-UP3 and new CU-UP controller is referred to as the eE1 interface; CU-UP controller and CU-CP is referred to as the eFx-C interface; CU-UP controller and eDU-CP is referred to as the eFz-C interface; eDU-CP and RANF or CU-CP is referred to as the eFy-C interface.

### Radio Bearer Protocol Architecture

In this architecture, the UE first establishes RRC connectivity with the CU-CP. The UE has a single RRC state based on the CU-CP RRC and a single C-plane connection towards the core network. Each of the nodes (CU-CP and eDU-CP) has its own RRC entity that may generate RRC PDUs to be sent to the UE.

As used herein, embodiments consider the RRC with the CU-CP as the primary RRC (pRRC) and the RRC with the eDU-CP as the secondary RRC (sRRC).

Two options can be considered for the routing of the RRC PDUs between the UE and the CU-CP. Note that although the focus herein is on uplink transmissions in the description, although the same principles apply for downlink transmissions.

Option a) The pRRC is encapsulated within the sRRC message and carried towards the CU-CP. This assumes that the sRRC reuses existing SRB/message [the primary RRC is part of container within the secondary RRC from the eDU].

Option b) A new SRB/LCID is defined to carry the sRRC message and only this is handled by the eDU or terminated at the eDU-CP. The pRRC messages pass through towards the CU-CP in other SRBs (terminated at the CU-CP PDCP) [the primary RRC is independent of the secondary RRC from the eDU].

In both the options, the CU-CP configures the SRB(s) using dedicated signaling. In option b), the pRRC procedures are as per the legacy implementation.

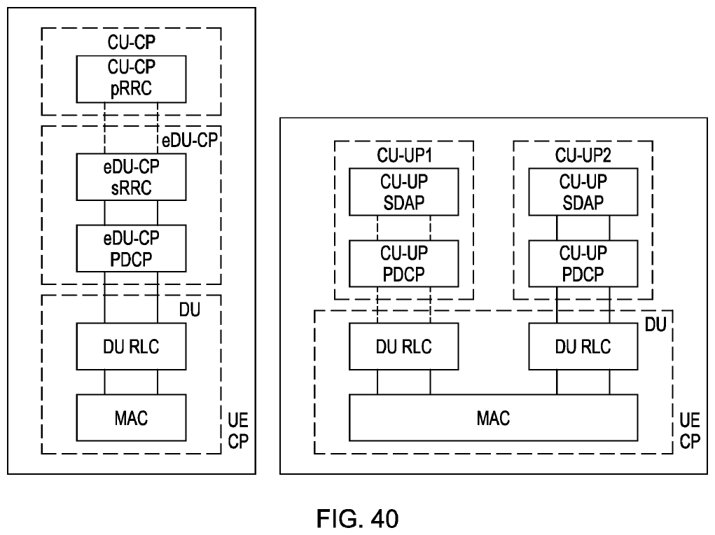

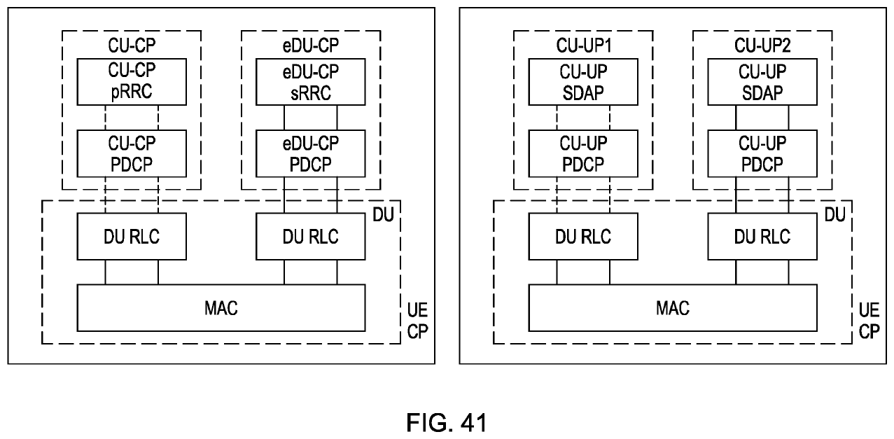

FIG. 40 illustrates a control plane and user plane protocol stack from the UE perspective in accordance with some embodiments. FIG. 41 illustrates another control plane and user plane protocol stack from the UE perspective in accordance with some embodiments. In one example, the UE is connected to the DU/eDU with a common PHY and MAC with two RLC entities and two PDCP entities, one PDCP towards the CU-CP and another towards the eDU-CP as shown in FIG. 41; while in FIG. 40, option a) is showcased of one PDCP for the sRRC and pRRC; in an extended example, the UE is connected to the DU/eDU with a common PHY and MAC with two RLC entities and two PDCP and SDAP entities, one PDCP & SDAP towards the CU-UP and another towards the eDU-UP as shown in user plane stack of FIGS. 40 and 41.

In general, multiple CU-UPs or eDU-UPs located in a distributed manner may be used for user plane support. The UE can be configured to support some bearers of a PDU/compute session via the eDU-UP located at the cell site (@ DU) and different bearers of another PDU session via the CU-UP located off site. This way the traffic can be routed in uplink correspondingly to the correct CU-UP.

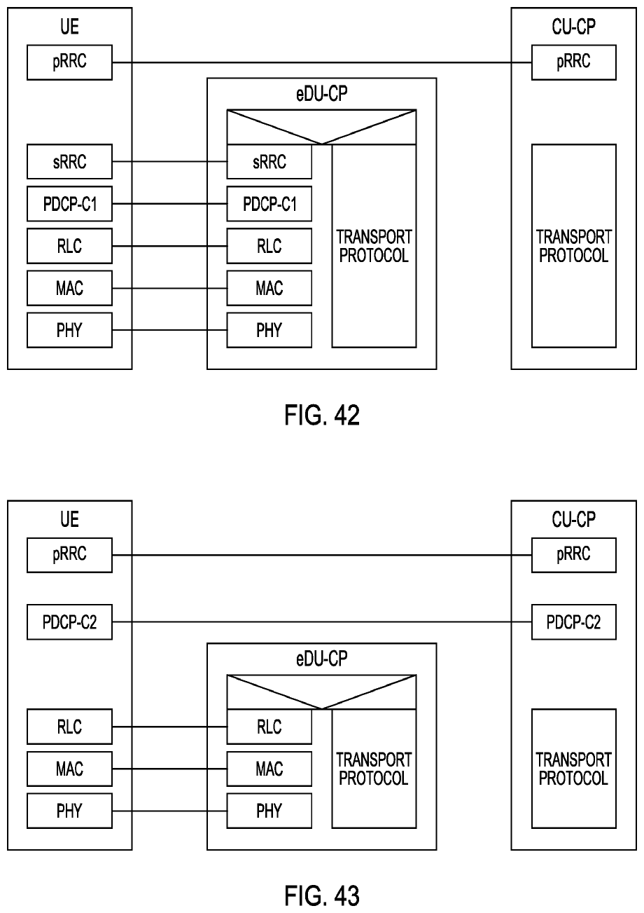

FIG. 42 illustrates a control plane protocol stack for the UE in accordance with some embodiments. FIG. 43 illustrates another control plane protocol stack for the UE in accordance with some embodiments. FIGS. 42 and 43 depict example protocol stacks for the control plane with option a) (with PDCP termination at the eDU-CP) and option b) (with PDCP termination at the CU-UP). As can be seen, with option a), the primary RRC signaling messages are encapsulated within the secondary RRC messages (using PDCP-C1 which refers to the PDCP entity corresponding to the eDU-CP) either as a message within a container or as a container with only the configuration/complete message contents. In option b), the primary RRC terminates between the UE and CU-CP using PDCP-C2 which refers to the PDCP entity corresponding to the CU-CP.

Context Retrieval from CU-CP

In one example, all of the UE context (including eDU related) is stored at the CU-CP when the UE moves to the RRC_INACTIVE state. In another example, the context stored at the CU-CP is retrieved by the eDU-CP over the eFy-C interface. In another example, the context includes at least the (e.g., SRB5 and DRB) configuration for the bearers supported at the eDU and the security configuration for the eDU-UP.

In another example, the context related to the eDU (i.e., the lower layer configuration and local user plane bearer configuration) may be stored at the eDU when the UE moves to RRC_INACTIVE.

### xNB Configuration Details and Signaling

In one example, the UE is configured to establish a special SRB (e.g., SRB5) with the eDU-CP to enable specific secondary RRC PDUs to be sent directly between the UE and the eDU-CP. These RRC PDUs do not require any coordination with the CU-CP. This SRB is configured by the CU-CP using dedicated signaling as discussed above.

In one example, once the UE is connected via the CU-CP (using primary RRC messages) and is in the RRC_CONNECTED state, the eDU-CP generates and provides configuration using dedicated signaling over SRB5 (i.e., the secondary RRC) including the PHY, MAC and RLC configuration for all the user plane traffic; and in yet another example, the eDU-CP provides all the UP (all layers) configuration for the user plane bearers (DRB(s)) configured to use the eDU-UP, i.e., those that are terminating at the eDU PDCP-U; and the security material to support bearers through the eDU-UP or terminating at the eDU PDCP-U. For example, the CU-CP provides the root key and each CU-UP has its own key and the UE supports multiple/different CU-UP keys as per configuration from the CU-CP/eDU-CP.

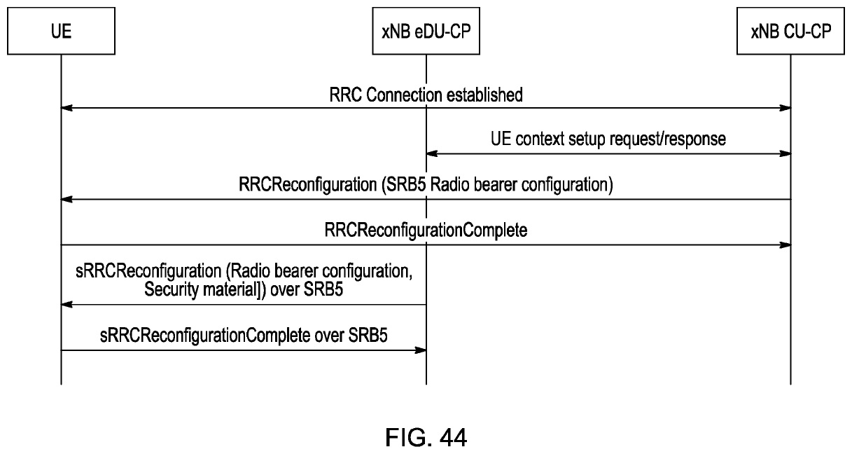

FIG. 44 illustrates signaling flow to support the eDU-CP in accordance with some embodiments. As shown in FIG. 44, once the UE has established the RRC connection with the CU-CP, the eDU-CP fetches the UE context from the central CU-CP. Thereafter the UE may be configured with the SRB5 configuration for usage with the eDU.

The UE and eDU can exchange sRRC messages with an indication or specific message identity or protocol discriminator that suggests that these messages are to be terminated at the eDU. These messages can be sent over SRB5 with a specified or configured logical channel ID for the case of option b) in which the sRRC and pRRC messages are sent individually/separated in this manner or may be sent using an existing/other/new SRB for option a) in which the pRRC messages are sent within a container of the sRRC.

An example of a sRRC message as shown in FIG. 44 is to provide configuration for the PHY, MAC and RLC for all the user plane traffic as well as the PDCP and SDAP configuration for the local user plane traffic terminating at the eDU itself.

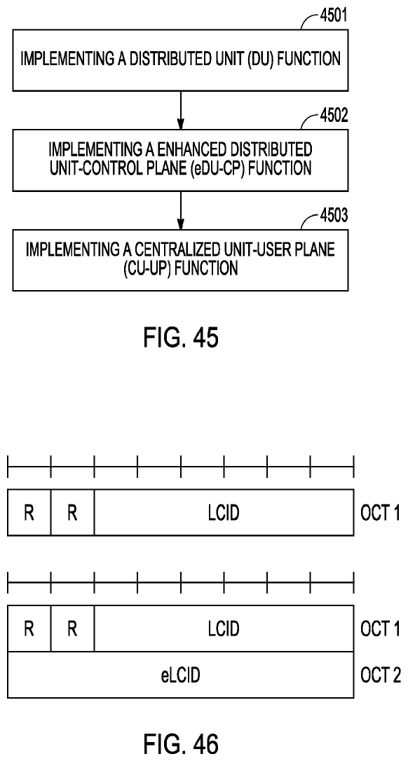

FIG. 45 shows a message process in accordance with some embodiments. The process of FIG. 45 may relate to a method to be performed by a base station, one or more elements of a base station, and/or an electronic device that includes or implements a base station. The process may include implementing, at 4501, a DU function; implementing, at 4502, an eDU-CP function; and implementing, at 4503, a CU-UP function.

### Control Signaling for eDU

As above, one gNB-DU is connected to only one gNB-CU-CP and all the RRC signaling sent to the UE originates at the CU-CP. Even if some of the signaling originally originated in the DU, it is sent to the CU-CP and then sent to the UE. This current RAN architecture causes increased signaling delay and is unnecessarily restrictive in this sense. There is additional delay associated with transfer of the RRC configuration from the DU to CU-CP before the RRC configuration can be sent to the UE. That is, additional signaling delays are caused when the CU-CP is placed in the cloud in a centralized location and also creates dependency between the DU and CU for lower layer configuration. The RRC messages originating at the CU-UP can be long and complex, and hence use a long processing time at the UE before the UE can update its configuration. The maximum processing time that a UE is able take for an RRC message from the CU-CP is specified by 3GPP.

There is increasing use of MAC CEs to avoid current RRC delay, which creates a security risk. A solution to this issue is provided herein by provisioning control plane signaling support at the DU. Specifically, the delay for the RRC messages is significantly reduced, making the RRC messages a suitable replacement for MAC CEs while also being security protected by a new PDCP function in the DU, thereby avoiding the security risks associated with the MAC CEs used today for controlling the PHY and MAC.

### MAC CE Mapping

MAC CE refers to a MAC Control Element as per TS 38.321. This is a special type of signaling in the MAC between the UE and the RAN (xNB) in both uplink and downlink using a special byte-aligned MAC Structure. It was introduced in LTE as a faster way to communicate with the UE (compared to RRC and NAS) and the list of supported MAC CEs continues to grow in NR.

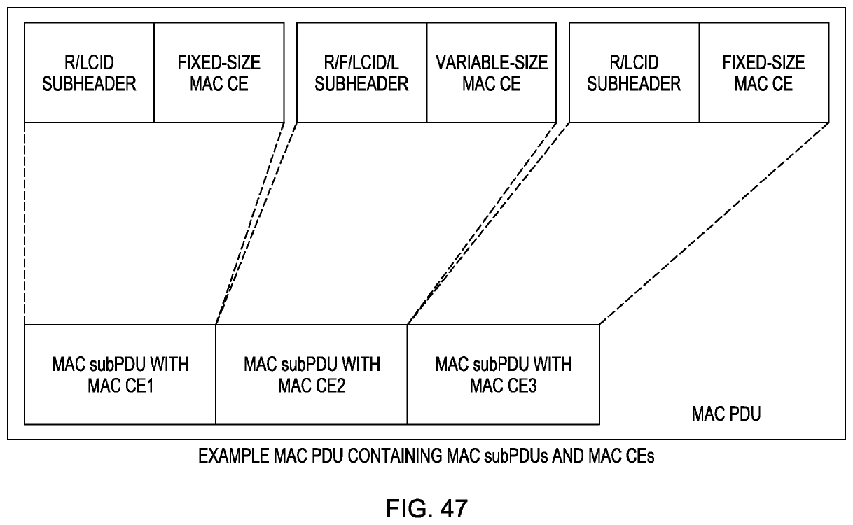

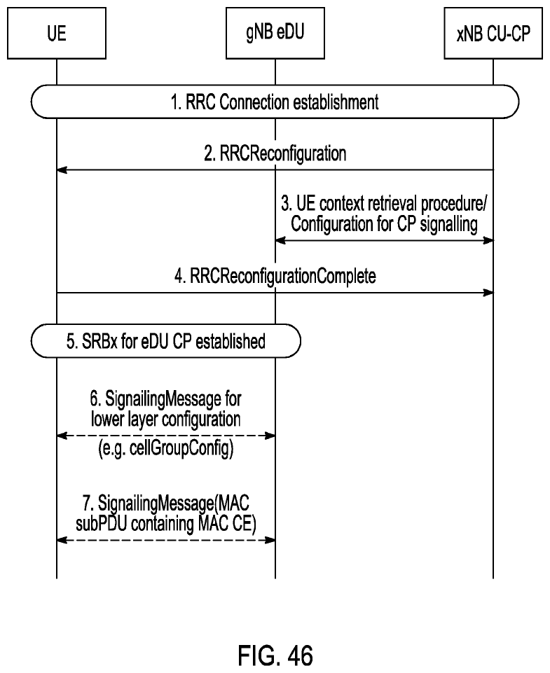

FIG. 46 shows a MAC subheader for a MAC CE in accordance with some embodiments. A MAC subPDU includes a MAC subheader and a MAC CE. The MAC subheader for MAC CE has two header fields R/LCID/(eLCID) as shown in FIG. 46.

Example tables of MAC CEs are shown below each for UL and DL:

TABLE 6.2.1-2
Values of LCID for UL-SCH (TS 38.321)

| Codepoint/ | |
|---|---|
| Index | LCID values |
| 0 | CCCH of size 64 bits (referred to as |
| | “CCCH1” in TS 38.331 [5]) |
| 1-32 | Identity of the logical channel |
| 33 | Extended logical channel ID field (two-octet eLCID field) |
| 34 | Extended logical channel ID field (one-octet eLCID field) |
| 35-44 | Reserved |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as |
| | “CCCH” in TS 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

TABLE 6.2.1-1
Values of LCID for DL-SCH(TS 38.321)

| Codepoint/ | |
|---|---|
| Index | LCID values |
| 0 | CCCH |
| 1-32 | Identity of the logical channel |
| 33 | Extended logical channel ID field (two-octet eLCID field) |
| 34 | Extended logical channel ID field (one-octet eLCID field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific PDSCH |
| 54 | Aperiodic CSI Trigger State Subselection |
| 55 | SP CSI-RS/CSI-IM Resource Set Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

Even as the popularity to use MAC CE is growing, there have been reports of security concerns of using a MAC CE since the MAC CE is sent in the clear with neither integrity protection nor encryption. For example, especially if the UE position information or measurements or other signaling that can be used to infer UE location are sent as MAC CE, the MAC CE may become available to an observer. At the same time the message should be communicated with the UE in a fast and secure manner.

A secure, encrypted signaling message similar to RRC signaling but simpler and smaller can be used to carry control information for L1 or L2 such as the MAC CEs that originate at the DU. At the same time, the delay in sending a RRC signaling message from the CU-CP can be somewhat mitigated if the RRC signaling message originated/terminated at the DU itself and the UE performance requirement to process these simpler RRC messages can be met. Security for the RRC messages is provided by a new PDCP protocol present in the DU itself. The new RRC message could be carried in a new signaling radio bearer.

It is hence possible to have almost equivalent delay performance along with security if RRC signaling message can be used between the UE and the DU in the place of MAC CEs to exchange commands (activation/deactivation) and other messages. There are a few ways by which this could be achieved:
a) Introduce a new signaling message (similar to that defined in below) with an RRC container that can include an entire MAC CE as is. As a variation to this option, instead of the MAC CE, a set of MAC CEs may be included. In one embodiment, the MAC subPDU format can be used to carry the multiple MAC CEs and may be sent within a single message/container.
b) Introduce a new signaling message that can encompass all the current and any future defined MAC CEs as optional fields.

For option a), an example signaling message with an RRC container is shown below; the message name itself can be representative of secondary RRC signaling and hence may potentially have a sRRC that is to be supported between the UE and eDU or refer to any other type of control plane signaling.

```
        SRRCSampleMessageDU
The sRRCSampleMessageDU message is used to transfer MAC CEs between the
DU to the UE.
      Signaling radio bearer: SRBx
      RLC-SAP: AM
      Logical channel: DCCH
      Direction: Network to UE/UE to Network
          sRRCSampleMessageDU message
-- ASN1START
-- TAG-SRRCSAMPLEMESSAGEDU-START
```

| | |
|---|---|
| sRRCSampleMessageDU-r19 ::= | SEQUENCE { |
| srrc-TransactionIdentifier | SRRC-TransactionIdentifier, |
| criticalExtensions | CHOICE { |
| sRRCSampleMessageDU-r19 | sRRCSampleMessageDU-r19-IEs, |
| criticalExtensionsFuture | SEQUENCE { } |

}
}

| | |
|---|---|
| sRRCSampleMessageDU-r19-IEs ::= | SEQUENCE { |
| sRRCSampleMessageDUContainer-r19 | OCTET STRING, |
| lateNonCriticalExtension | OCTET STRING |

OPTIONAL,

| | |
|---|---|
| nonCriticalExtension | SEQUENCE { } |

OPTIONAL
}
-- TAG-SRRCSAMPLEMESSAGEDU-STOP
-- ASN1STOP

FIG. 47 shows a MAC packet data unit (PDU) containing MAC subPDUs with MAC CEs in accordance with some embodiments. An example of the MAC subPDU that encompasses multiple MAC CEs with headers that could be sent within the container is shown in FIG. 47.

For option b), an example signaling message encompassing some of the MAC CE fields as individual optional fields is shown below.

The MAC subPDU may be generated by the MAC protocol layer and sent to the RRC layer in the DU. The RRC layer in the DU then puts together a “simple” RRC message and sends the RRC message to the UE, for example over the new SRB logical channel.

```
SRRCSampleMessageFieldsDU
The sRRCSampleMessageFieldsDU message is used to transfer MAC CEs
between the DU to the UE.
  Signaling radio bearer: SRBx
  RLC-SAP: AM
  Logical channel: DCCH
  Direction: Network(DU) to UE/UE to Network(DU)
        sRRCSampleMessageFieldsDU message
-- ASN1START
-- TAG-SRRCSAMPLEMESSAGEFIELDSDU-START
```

| | |
|---|---|
| sRRCSampleMessageFIELDSDU-r19 ::= | SEQUENCE { |
| srrc-TransactionIdentifier | SRRC-TransactionIdentifier, |
| criticalExtensions | CHOICE { |
| sRRCSampleMessageFieldsDU-r19 | sRRCSampleMessageFieldsDU- |

r19-IEs,

| | |
|---|---|
| criticalExtensionsFuture | SEQUENCE { } |

}
}

| | |
|---|---|
| sRRCSampleMessageFieldsDU-r19-IEs ::= | SEQUENCE { |
| timing-Delta | INTEGER (0..1199) |

OPTIONAL,

| | |
|---|---|
| multipleEntry-CGConfirmation | BIT STRING (SIZE (32)) |

OPTIONAL,

| | |
|---|---|
| duplicationActivationDeActivation | BIT STRING (SIZE (8)) |

```
      OPTIONAL,
    .....
    .....
    .....
```

| | |
|---|---|
| lateNonCriticalExtension | OCTET STRING |

OPTIONAL,

| | |
|---|---|
| nonCriticalExtension | SEQUENCE { } |

OPTIONAL
}
-- TAG-SRRCSAMPLEMESSAGEDU-STOP
-- ASN1STOP

### AF1792 Support of New Signaling at the eDU

As above, an eDU may be used. The eDU contains control plane support sublayers RRC and PDCP-C to carry the PHY/MAC/RLC configuration directly towards the UE instead of being sent to CU-CP in a container to be sent back to the UE. Further enhancements may be used to reduce the delay associated with signaling and enable the signaling mechanisms for the eDU to provide lower layer configurations directly to the UE.

Accordingly, a new signaling message or a group of messages may be defined that are primarily supported at the eDU and enabled with the configuration from the CU-CP. Some of the characteristics of these messages that may be simple and used for basic exchange of commands, while other messages may be large and complex and can include the following: the signaling can be based on RRC or involve a new mechanism; the control plane messages are secured end-to-end between the UE and the eDU via PDCP-C residing at the eDU; and segmentation of the message (especially in case of option b) above) is allowed.

In one example, the CU-CP provides a configuration to enable the eDU signaling of these new DU-originated RRC messages after security is activated at the UE via security mode command exchange. The CU-CP provides the configuration (e.g., new signaling radio bearer) to the eDU and the UE. In another example, when the network provides configuration parameters for cell group in the cellGroupConfig IE that may contain related lower layer configuration IEs (mac-CellGroupConfig, rlc-BearerToAddModList etc), it is carried from the eDU to the UE without being sent to the CU-CP over F1AP. An example of such configuration is shown below:

```
- sRRCCellGroupConfiguration
The sRRCCellGroupConfiguration message is used to transfer lower layer
configuration from the DU to the UE.
  Signaling radio bearer: SRBx
  RLC-SAP: AM
  Logical channel: DCCH
  Direction: Network (DU) to UE
        sRRCCellGroupConfiguration message
-- ASN1START
-- TAG-sRRCCELLGROUPCONFIGURATION-START
```

| | |
|---|---|
| sRRCCellGroupConfiguration-r19 ::= | SEQUENCE { |
| srrc-TransactionIdentifier | SRRC-TransactionIdentifier, |
| criticalExtensions | CHOICE { |
| sRRCCellGroupConfiguration -r19 | sRRCCellGroupConfiguration- |

r19-IEs,

| | |
|---|---|
| criticalExtensionsFuture | SEQUENCE { } |

}
}

| | |
|---|---|
| sRRCCellGroupConfiguration-r19-IEs ::= | SEQUENCE { |
| srrc-CellGroupConfigurationContainer-r19 | OCTET STRING, |
| lateNonCriticalExtension | OCTET STRING |

OPTIONAL,

| | |
|---|---|
| nonCriticalExtension | SEQUENCE { } |

OPTIONAL
}
-- TAG-sRRCCELLGROUPCONFIGURATION-STOP
-- ASN1STOP

For the RRC messages that contain the lower layer configuration (e.g., cellGroupConfig) and may be large and complex, it may not be possible to include all of the configuration in one message. The size of the message is constrained by the maximum PDU size supported by the PDCP. When this is exceeded, the message may be segmented at RRC layer and sent as several RRC messages (e.g., S_DLDedicatedMessageSegment), each containing one segment of the original message similar to what is done for RRCReconfiguration message. The UE first accumulates all of the RRC message segments and assembles together the original RRC message before processing that message. The DLDedicatedMessageSegment can be defined as follows:

```
- S_DLDedicatedMessageSegment
The S_DLDedicatedMessageSegment message is used to transfer one
segment of the sRRCReconfiguration/sRRCCellGroupConfiguration
messages.
  Signaling radio bearer: SRBx
  RLC-SAP: AM
  Logical channel: DCCH
  Direction: Network (DU) to UE
        S_DLDedicatedMessageSegment message
-- ASN1START
-- TAG-S_DLDEDICATEDMESSAGESEGMENT-START
```

| | |
|---|---|
| S_DLDedicatedMessageSegment-r16 ::= | SEQUENCE { |
| criticalExtensions | CHOICE { |

sDlDedicatedMessageSegment-r16
S_DLDedicatedMessageSegment-r16-IEs,

| | |
|---|---|
| criticalExtensionsFuture | SEQUENCE { } |

}
}

| | |
|---|---|
| S_DLDedicatedMessageSegment-r16-IEs ::= | SEQUENCE { |
| segmentNumber-r16 | INTEGER(0..4), |
| srrc-MessageSegmentContainer-r16 | OCTET STRING, |
| srrc-MessageSegmentType-r16 | ENUMERATED |

{notLastSegment, lastSegment},

| | |
|---|---|
| lateNonCriticalExtension | OCTET STRING |

OPTIONAL,

| | |
|---|---|
| nonCriticalExtension | SEQUENCE { } |

OPTIONAL
}
-- TAG-S_DLDEDICATEDMESSAGESEGMENT-STOP
-- ASN1STOP

### Signaling Flow

FIG. 48 shows control plane signaling flow at an eDU in accordance with some embodiments. In FIG. 48:

At step 1, the UE establishes an RRC connection with the network.

At step 2, the gNB CU-CP configures the UE by sending an RRCReconfiguration message with configuration information to initiate signaling with the gNB eDU.

At step 3, the gNB CU-CP configures the gNB eDU with the configuration information to initiate signaling with the UE.

At step 4, the UE sends an RRCReconfigurationComplete message toward the gNB eDU.

At step 5, a new signaling radio bearer is established between the UE and the gNB eDU to exchange control plane signaling messages.

At step 6, the gNB eDU generates a new control plane signaling message to provide a lower layer configuration towards the UE.

At step 7, the gNB eDU and UE exchange the new control plane signaling message to communicate MAC subPDUs containing MAC CEs (L1/L2 command/control activation/deactivation, etc.).

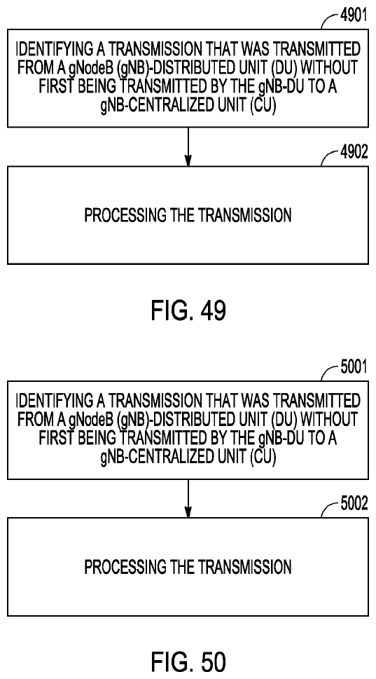

FIG. 49 shows a message process in accordance with some embodiments. The process may include or relate to a method to be performed by a UE, one or more elements of a UE, and/or an electronic device that includes or implements the UE. The process of FIG. 49 may include identifying, at 4901, a transmission that was transmitted from a gNB-DU without first being transmitted by the gNB-DU to a gNB-CU; and processing, at 4902, the transmission.

FIG. 50 shows another message process in accordance with some embodiments. The process may include or relate to a method to be performed by a gNB-DU, one or more elements of a gNB-DU, and/or an electronic device that includes or implements the gNB-DU. The process of FIG. 50 may include identifying, at 5001, a transmission that is to be transmitted to a UE; and transmitting, at 5002, the transmission to the UE without first transmitting the transmission to a gNB-CU.

### EXAMPLES

Example 1 is an apparatus for a next generation NodeB (xNB), the apparatus comprising: memory; and processing circuitry, to configure the xNB to: provide a central unit-control plane (CU-CP) as part of control plane network functions in a service-based architecture via a service based interface (SBI) over an N₂ interface; and receive and respond to a request from a user equipment (UE) for services from a network function (NF) via the CU-CP, the request comprising a NF identifier (ID) of the NF or a service ID and message contents for the NF; and wherein the memory is configured to store the request.

In Example 2, the subject matter of Example 1 includes, wherein the processing circuitry configures the xNB to: receive, from the UE, capability information indicating support of the service-based architecture; and provide, to the UE, configuration and system information for support of the SBI.

In Example 3, the subject matter of Examples 1-2 includes, wherein the processing circuitry configures the xNB to: receive, from the UE, a radio resource control (RRC) message, the RRC message comprising information elements that include a message type, the NF ID, service operation details, and specific service message information to communicate a distributed non-access stratum (NAS) message to the NF via the CU-CP, the information elements encrypted using access stratum (AS) encryption; based on the RRC message, use the N2 interface to forward a hypertext transfer protocol secure (HTTPS) message to the NF; and provide, to the UE, a response to the RRC message with a response received from the NF within a DLNetworkFunctionInformation Transfer message.

In Example 4, the subject matter of Examples 1-3 includes, wherein the processing circuitry configures the xNB to: receive, from the UE, a radio resource control (RRC) message, the RRC message comprising information elements that include a message type, the NF ID, service operation details, and distributed non-access stratum (NAS) specific service message information to communicate a distributed NAS message to the NF via the CU-CP, the distributed NAS specific service message information encrypted using NAS encryption; based on the RRC message, use the N2 interface to forward a hypertext transfer protocol secure (HTTPS) message to the NF; and provide, to the UE, a response to the RRC message with a response received from the NF within a DLNetworkFunctionInformationTransfer message.

In Example 5, the subject matter of Examples 1~4 includes, wherein the processing circuitry configures the xNB to: receive, from the UE, a radio resource control (RRC) message, the RRC message comprising information elements that include a message type indicating ‘direct transfer’ or ‘forward/relay transfer’, the NF ID, and a distributed non-access stratum (NAS) service message to communicate the distributed NAS message containing service operation details to the NF via the CU-CP, the distributed NAS service message encrypted using NAS encryption; based on the RRC message, use the N2 interface to forward a hypertext transfer protocol secure (HTTPS) message to the NF; and provide, to the UE, a response to the RRC message with a response received from the NF within a DLNetworkFunctionInformationTransfer message.

In Example 6, the subject matter of Examples 1-5 includes, wherein the processing circuitry configures the xNB to: query, based on information in at least one of a distributed non-access stratum (NAS) message or a radio resource control (RRC) message from the UE to serve distributed NAS messages of the UE towards NFs, a network repository function (NRF) for an NF instance; and select a particular NF instance based on at least one of: the at least one of the distributed NAS message or RRC message, or information assigned during registration and stored as part of context information of the UE.

In Example 7, the subject matter of Example 6 includes, wherein: the distributed NAS message is visible to the CU-CP, and the processing circuitry configures the xNB to generate one of a hypertext transfer protocol (HTTP) message or a hypertext transfer protocol secure (HTTPS) message including a uniform resource identifier (URI) {apiRoot}////based on the distributed NAS message.

In Example 8, the subject matter of Examples 6-7 includes, wherein the distributed NAS message is not visible to CU-CP.

In Example 9, the subject matter of Examples 6-8 includes, wherein: the distributed NAS message is encrypted between the UE and the particular NF instance, and at least one information element in the RRC message that indicates a service operation of the NF and a container type is used to generate a uniform resource identifier (URI) {apiRoot}////.

In Example 10, the subject matter of Examples 6-9 includes, wherein: the distributed NAS message is encrypted between the UE and the particular NF instance, at least one information element in the RRC message that indicates a service operation of the NF and a 4-bit payload container type is used to determine a type of the NF, and a general service operation Nnf_distributedNASTransfer_request and Nnf_distributedNASTransfer_response are included in a table of all NF service operations.

In Example 11, the subject matter of Examples 1-10 includes, wherein: a hypertext transfer protocol (HTTP) message transmitted between the NF and the CU-CP over the SBI is encrypted between the UE and the CU-CP, and the processing circuitry configures the CU-CP to use a HTTP traffic filter to route the HTTP message, the HTTP traffic filter including a target field, a matching rule, and a routing rule, the HTTP traffic filter generated on a per-UE basis by a policy control function (PCF) and stored as part of a UE context.

In Example 12, the subject matter of Examples 1-11 includes, wherein: a hypertext transfer protocol (HTTP) message transmitted between the UE and the NF over the SBI is encrypted between the UE and the NF, the HTTP message is carried in a radio resource control (RRC) message container, a container type of the RRC message indicates an NF type of the NF, and the processing circuitry configures the CU-CP to encapsulate an HTTP message between the UE and NF into a new HTTP message over the N2 interface.

In Example 13, the subject matter of Examples 1-12 includes, wherein: a hypertext transfer protocol (HTTP) message transmitted between the NF and the CU-CP over the SBI is encrypted, the HTTP message is carried in a radio resource control (RRC) message container, a container type of the RRC message indicates an NF type of the NF, and the processing circuitry configures the CU-CP to encapsulate an HTTP message between the UE and NF into a Transmission Control Protocol/Internet Protocol (TCP/IP) packet with an IPv6 address assigned to the UE used as a source IP address and an IP address assigned to the NF as a destination IP address, the IPv6 address in the form of domain: endpoint and the CU-CP identified by a domain name.

In Example 14, the subject matter of Examples 1-13 includes, wherein: a hypertext transfer protocol (HTTP) message transmitted between the UE and the NF over the SBI is encrypted between the UE and a gateway (GW) between a radio access network (RAN) and a core network (CN), and the processing circuitry configures the CU-CP to route the HTTP message to the GW between RAN and CN based on identifiers in a UE context.

In Example 15, the subject matter of Example 14 includes, wherein: the GW is an enhanced service communication proxy control plane (eSCP-C) ingress/egress GW for a control plane service mesh, and the eSCP-C is configured by a service infrastructure control function (SICF) of a HTTP traffic filter to route the HTTP message to a NF instance.

In Example 16, the subject matter of Examples 1-15 includes, interface.

In Example 17, the subject matter of Examples 1-16 includes, wherein the processing circuitry configures the xNB to: receive, from the UE, a radio resource control (RRC) message with a message type, the NF ID, service operation details, and specific service message information using Packet Data Convergence Control (PDCP) encryption as part of a SBI message using a hypertext transfer protocol (HTTP) protocol to communicate to the NF; based on the RRC message, use the N2 interface to forward a hypertext transfer protocol secure (HTTPS) message to the NF; and provide, to the UE, a response to the RRC message with a response received from the NF within a DLNetworkFunctionInformationTransfer message.

In Example 18, the subject matter of Examples 1-17 includes, wherein the processing circuitry configures the xNB to: receive, from the UE, a radio resource control (RRC) message with a message type, the NF ID, service operation details, and an encrypted SBI message using a hypertext transfer protocol (HTTP) protocol specific service message information with non-access stratum (NAS) encryption to communicate the RRC message to the NF; based on the RRC message, use the N2 interface to forward to the NF a hypertext transfer protocol secure (HTTPS) message with a body having a container of the RRC message; and provide, to the UE, a response to the RRC message with a response received from the NF within a DLNetworkFunctionInformationTransfer message.

In Example 19, the subject matter of Examples 1-18 includes, wherein the processing circuitry configures the xNB to: receive, from the UE, a radio resource control (RRC) message comprising a message type indicating ‘direct transfer’ or ‘forward/relay transfer’, the NF ID, and a non-access stratum (NAS) encrypted SBI message using a hypertext transfer protocol (HTTP) protocol to communicate a message containing service operation details to the NF via the CU-CP; based on the RRC message, use the N2 interface to forward a hypertext transfer protocol secure (HTTPS) message to the NF; and provide, to the UE, a response to the RRC message with a response received from the NF within a DLNetworkFunctionInformationTransfer message.

In Example 20, the subject matter of Examples 1-19 includes, wherein: the UE is able to support simultaneous connectivity to multiple central unit-user planes (CU-UPs) and a Distributed Unit (DU) of the xNB is able to support control plane methods for configuration of user plane data handled locally at the DU, and the DU supports Packet Data Convergence Control (PDCP) and radio resource control (RRC) layers, Service Data Adaptation Protocol (SDAP) layers, and an enhanced Distributed Unit (eDU) of the xNB, and coordinates with the CU-CP to control multiple distributed CU-UPs and an enhanced Distributed Unit-User Plane (eDU-UP) or a UP unit local to the DU to handle user plane traffic of the UE.

In Example 21, the subject matter of Example 20 includes, wherein an enhanced Distributed Unit-Control Plane (eDU-CP) is configured to fetch UE context from the CU-CP based on network deployment and UE authorization to support local services.

In Example 22, the subject matter of Examples 20-21 includes, wherein user plane resources are available at the eDU for predetermined services that use specific QoS requirements.

In Example 23, the subject matter of Examples 20-22 includes, wherein a signaling radio bearer is configured for the UE by the CU-CP or a radio access network (RAN) function to support secondary RRC signaling with an enhanced Distributed Unit-Control Plane (eDU-CP).

In Example 24, the subject matter of Examples 20-23 includes, wherein primary RRC signaling between the UE and the CU-CP is encapsulated within secondary RRC signaling between the UE and an enhanced Distributed Unit-Control Plane (eDU-CP).

In Example 25, the subject matter of Examples 20-24 includes, wherein an enhanced Distributed Unit-Control Plane (eDU-CP) is configured to use dedicated signaling to configure the UE with a Physical (PHY), Medium Access Control (MAC), and Radio Link Control (RLC) configuration for user plane traffic and a PDCP and SDAP configuration for user plane traffic terminating at the eDU.

In Example 26, the subject matter of Examples 1-25 includes, wherein: a Distributed Unit (DU) of the xNB and the UE carry Layer1 (L1) and Layer2 (L2) control information within control plane signaling, and the DU is configured by the CU-CP to provide lower layer configuration and control information to the UE.

In Example 27, the subject matter of Examples 1-26 includes, wherein: a Distributed Unit (DU) of the xNB and the UE carry Layer1 (L1) and Layer2 (L2) control information within control plane signaling, and the DU supports Packet Data Convergence Control (PDCP) protocol to provide security for signaling of the L1 and L2 control information and lower layer configuration.

In Example 28, the subject matter of Example 27 includes, wherein the processing circuitry is configured to send a cell group configuration from the DU to the UE within a signaling message as a container.

In Example 29, the subject matter of Example 28 includes, wherein segmentation of signaling message exchange between the DU and the UE is supported.

In Example 30, the subject matter of Example 29 includes, wherein the cell group configuration is carried as multiple message segments when an original message size exceeds a predetermined limit.

In Example 31, the subject matter of Examples 1-30 includes, wherein: a Distributed Unit (DU) of the xNB and the UE carry Layer1 (L1) and Layer2 (L2) control information within control plane signaling, and the control plane signaling uses a signaling radio bearer defined specifically for communication from the DU to the UE.

In Example 32, the subject matter of Examples 1-31 includes, wherein: a Distributed Unit (DU) of the xNB and the UE carry Layer1 (L1) and Layer2 (L2) control information within control plane signaling, and the control plane signaling uses a container to carry multiple Medium Access Control (MAC) Control Elements (CEs) using a MAC sub PacketDataUnit (subPDU) format.

In Example 33, the subject matter of Examples 1-32 includes, wherein: a Distributed Unit (DU) of the xNB and the UE carry Layer1 (L1) and Layer2 (L2) control information within control plane signaling, and the control plane signaling uses optional Information Element (IE) fields to carry multiple Medium Access Control (MAC) Control Elements (CEs).

In Example 34, the subject matter of Examples 1-33 includes, wherein a radio resource control (RRC) message is defined as a simple message with only control information or minimal configuration, and a UE processing time defined for the RRC message is smaller than a UE processing time of a RRC message of normal size and complexity.

Example 35 is an apparatus for a user equipment (UE), the apparatus comprising: memory; and processing circuitry, to configure the UE to: send, to a central unit-control plane (CU-CP) of a next generation NodeB (xNB), a request for services from a network function (NF), the CU-CP providing part of control plane network functions in a service-based architecture via a service based interface (SBI) over an N₂ interface, the request comprising a NF identifier (ID) of the NF or a service ID and message contents for the NF; and receive, from the xNB, a response to the request; and wherein the memory is configured to store the response.

In Example 36, the subject matter of Example 35 includes, wherein the processing circuitry configures the UE to: send, to the CU-CP, capability information indicating support of the service-based architecture; and receive, from the CU-CP, configuration and system information for support of the SBI.

Example 37 is a computer-readable storage medium that stores instructions for execution by one or more processors of a next generation NodeB (xNB), the one or more processors to configure the xNB, when the instructions are executed: provide a central unit-control plane (CU-CP) as part of control plane network functions in a service-based architecture via a service based interface (SBI) over an N₂ interface; and receive and respond to a request from a user equipment (UE) for services from a network function (NF) via the CU-CP, the request comprising a NF identifier (ID) of the NF or a service ID and message contents for the NF.

In Example 38, the subject matter of Example 37 includes, wherein the instructions, when executed, configure the xNB to: receive, from the UE, capability information indicating support of the service-based architecture; and provide, to the UE, configuration and system information for support of the SBI.

Example 39 is at least one machine-readable medium including instructions that, when executed by processing circuitry, cause the processing circuitry to perform operations to implement of any of Examples 1-38.

Example 40 is an apparatus comprising means to implement of any of Examples 1-38.

Example 41 is a system to implement of any of Examples 1-38.

Example 42 is a method to implement of any of Examples 1-38.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In various embodiments, an element referred to as “a”, if multiple of the elements are present may provide the functionality indicated by the element alone or in combination with the other elements (i.e., each of the elements may provide different and perhaps overlapping functionality). In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus for a next generation NodeB (xNB), the apparatus comprising: processing circuitry configured to:
provide a central unit-control plane (CU-CP) as part of control plane network functions in a service-based architecture via a service based interface (SBI) over an N2 interface; and
decode and generate a response to a request from a user equipment (UE) for services from a network function (NF) via the CU-CP, the request comprising a NF identifier (ID) of the NF or a service ID and message contents for the NF; and memory configured to store the request.

22. The apparatus of claim 21, wherein the processing circuitry is further configured to:
decode, from the UE, capability information indicating support of the service-based architecture; and
encode, for transmission to the UE, configuration and system information for support of the SBI.

23. The apparatus of claim 21, wherein the processing circuitry is further configured to:
decode, from the UE, a radio resource control (RRC) message, the RRC message comprising information elements that include a message type, the NF ID, service operation details, and specific service message information to communicate a distributed non-access stratum (NAS) message to the NF via the CU-CP, the information elements encrypted using access stratum (AS) encryption;
Title: 6G CONTROL PLANE NETWORK FUNCTIONS IN SERVICE-BASED ARCHITECTURE based on the RRC message, use the N2 interface to forward a hypertext transfer protocol secure (HTTPS) message to the NF; and
encode, for transmission to the UE, a response to the RRC message with a response received from the NF within a DLNetworkFunctionInformationTransfer message.

24. The apparatus of claim 21, wherein the processing circuitry is further configured to:
receive, from the UE, a radio resource control (RRC) message, the RRC message comprising information elements that include a message type, the NF ID, service operation details, and distributed non-access stratum (NAS) specific service message information to communicate a distributed NAS message to the NF via the CU-CP, the distributed NAS specific service message information encrypted using NAS encryption;
based on the RRC message, use the N2 interface to forward a hypertext transfer protocol secure (HTTPS) message to the NF; and
provide, to the UE, a response to the RRC message with a response received from the NF within a DLNetworkFunctionInformationTransfer message.

25. The apparatus of claim 21, wherein the processing circuitry is further configured to:
receive, from the UE, a radio resource control (RRC) message, the RRC message comprising information elements that include a message type indicating ‘direct transfer’ or ‘forward/relay transfer’, the NF ID, and a distributed non-access stratum (NAS) service message to communicate the distributed NAS message containing service operation details to the NF via the CU-CP, the distributed NAS service message encrypted using NAS encryption;
based on the RRC message, use the N2 interface to forward a hypertext transfer protocol secure (HTTPS) message to the NF; and
provide, to the UE, a response to the RRC message with a response received from the NF within a DLNetworkFunctionInformationTransfer message.

26. The apparatus of claim 21, wherein the processing circuitry is further configured to:
query, based on information in at least one of a distributed non-access stratum (NAS) message or a radio resource control (RRC) message from the UE to serve distributed NAS messages of the UE towards NFs, a network repository function (NRF) for an NF instance; and
select a particular NF instance based on at least one of:
the at least one of the distributed NAS message or RRC message, or
information assigned during registration and stored as part of context information of the UE.

27. The apparatus of claim 26, wherein:
the distributed NAS message is visible to the CU-CP, and
the processing circuitry is further configured to generate one of a hypertext transfer protocol (HTTP) message or a hypertext transfer protocol secure (HTTPS) message including a uniform resource identifier (URI) {apiRoot}/<apiName>/<apiVersion>/<apiSpecificResourceUriPart>/<custOpName> based on the distributed NAS message.

28. The apparatus of claim 26, wherein:
the distributed NAS message is encrypted between the UE and the particular NF instance, and
at least one of:
at least one information element (IE) in the RRC message that indicates a service operation of the NF and a container type is used to generate a uniform resource identifier (URI) {apiRoot}/<apiName>/<apiVersion>/<apiSpecificResourceUriPart>/<custOpName>, or
at least one IE in the RRC message that indicates a service operation of the NF and a 4-bit payload container type is used to determine a type of the NF, and a general service operation Nnf_distributedNASTransfer_request and Nnf_distributedNASTransfer_response are included in a table of all NF service operations.

29. The apparatus of claim 21, wherein at least one of:
a hypertext transfer protocol (HTTP) message transmitted between the NF and the CU-CP over the SBI is encrypted between the UE and the CU-CP, and the processing circuitry configures the CU-CP to use a HTTP traffic filter to route the HTTP message, the HTTP traffic filter including a target field, a matching rule, and a routing rule, the HTTP traffic filter generated on a per-UE basis by a policy control function (PCF) and stored as part of a UE context,
a HTTP message transmitted between the UE and the NF over the SBI is encrypted between the UE and the NF, the HTTP message is carried in a radio resource control (RRC) message container, a container type of the RRC message indicates an NF type of the NF, and the processing circuitry configures the CU-CP to encapsulate an HTTP message between the UE and NF into a new HTTP message over the N2 interface, or
a HTTP message transmitted between the NF and the CU-CP over the SBI is encrypted, the HTTP message is carried in a RRC message container, a container type of the RRC message indicates an NF type of the NF, and the processing circuitry configures the CU-CP to encapsulate an HTTP message between the UE and NF into a Transmission Control Protocol/Internet Protocol (TCP/IP) packet with an IPv6 address assigned to the UE used as a source IP address and an IP address assigned to the NF as a destination IP address, the IPv6 address being in a form of domain: endpoint and the CU-CP identified by a domain name.

30. The apparatus of claim 21, wherein:
a hypertext transfer protocol (HTTP) message transmitted between the UE and the NF over the SBI is encrypted between the UE and a gateway (GW) between a radio access network (RAN) and a core network (CN), and
the processing circuitry is further configured to route the HTTP message to the GW between RAN and CN based on identifiers in a UE context.

31. The apparatus of claim 30, wherein:
the GW is an enhanced service communication proxy control plane (eSCP-C) ingress/egress GW for a control plane service mesh, and
the eSCP-C is configured by a service infrastructure control function (SICF) of a HTTP traffic filter to route the HTTP message to a NF instance.

32. The apparatus of claim 21, wherein the processing circuitry is further configured to:
decode, from the UE, a radio resource control (RRC) message with a message type, the NF ID, service operation details, and specific service message information using Packet Data Convergence Control (PDCP) encryption as part of a SBI message using a hypertext transfer protocol (HTTP) protocol to communicate to the NF;
based on the RRC message, use the N2 interface to forward a hypertext transfer protocol secure (HTTPS) message to the NF; and
encode, for transmission to the UE, a response to the RRC message with a response received from the NF within a DLNetworkFunctionInformationTransfer message.

33. The apparatus of claim 21, wherein the processing circuitry is further configured to:
decode, from the UE, a radio resource control (RRC) message with a message type, the NF ID, service operation details, and an encrypted SBI message using a hypertext transfer protocol (HTTP) protocol specific service message information with non-access stratum (NAS) encryption to communicate the RRC message to the NF;
based on the RRC message, use the N2 interface to forward to the NF a hypertext transfer protocol secure (HTTPS) message with a body having a container of the RRC message; and
encode, for transmission to the UE, a response to the RRC message with a response received from the NF within a DLNetworkFunctionInformationTransfer message.

34. The apparatus of claim 21, wherein the processing circuitry is further configured to:
decode, from the UE, a radio resource control (RRC) message comprising a message type indicating ‘direct transfer’ or ‘forward/relay transfer’, the NF ID, and a non-access stratum (NAS) encrypted SBI message using a hypertext transfer protocol (HTTP) protocol to communicate a message containing service operation details to the NF via the CU-CP;
based on the RRC message, use the N2 interface to forward a hypertext transfer protocol secure (HTTPS) message to the NF; and
encode, for transmission to the UE, a response to the RRC message with a response received from the NF within a DLNetworkFunctionInformationTransfer message.

35. The apparatus of claim 21, wherein:
the UE is able to support simultaneous connectivity to multiple central unit-user planes (CU-UPs) and a Distributed Unit (DU) of the xNB is able to support control plane methods for configuration of user plane data handled locally at the DU, and
the DU supports Packet Data Convergence Control (PDCP) and radio resource control (RRC) layers, Service Data Adaptation Protocol (SDAP) layers, and an enhanced Distributed Unit (eDU) of the xNB, and coordinates with the CU-CP to control multiple distributed CU-UPs and an enhanced Distributed Unit-User Plane (eDU-UP) or a UP unit local to the DU to handle user plane traffic of the UE.

36. The apparatus of claim 21, wherein:
a Distributed Unit (DU) of the xNB and the UE carry Layer1 (L1) and Layer2 (L2) control information within control plane signaling, and at least one of:
the DU is configured by the CU-CP to provide lower layer configuration and control information to the UE,
the DU supports Packet Data Convergence Control (PDCP) protocol to provide security for signaling of the L1 and L2 control information and lower layer configuration,
the control plane signaling uses a signaling radio bearer defined specifically for communication from the DU to the UE,
the control plane signaling uses a container to carry multiple Medium Access Control (MAC) Control Elements (CEs) using a MAC sub PacketDataUnit (subPDU) format, or
the control plane signaling uses optional Information Element (IE) fields to carry multiple MAC CEs.

37. An apparatus for a user equipment (UE), the apparatus comprising:
processing circuitry configured to:
encode, for transmission to a central unit-control plane (CU-CP) of a next generation NodeB (xNB), a request for services from a network function (NF), the CU-CP providing part of control plane network functions in a service-based architecture via a service based interface (SBI) over an N₂ interface, the request comprising a NF identifier (ID) of the NF or a service ID and message contents for the NF; and
decode, from the xNB, a response to the request; and
memory configured to store the response.

38. The apparatus of claim 37, wherein the processing circuitry configures the UE to:
encode, for transmission to the CU-CP, capability information indicating support of the service-based architecture; and
decode, from the CU-CP, configuration and system information for support of the SBI.

39. A non-transitory computer-readable storage medium that stores instructions for execution by one or more processors of a next generation NodeB (xNB), the one or more processors to configure the xNB, when the instructions are executed:
provide a central unit-control plane (CU-CP) as part of control plane network functions in a service-based architecture via a service based interface (SBI) over an N₂ interface; and
decode and generate a response to a request from a user equipment (UE) for services from a network function (NF) via the CU-CP, the request comprising a NF identifier (ID) of the NF or a service ID and message contents for the NF.

40. The non-transitory computer-readable storage medium of claim 39, wherein the instructions, when executed, configure the xNB to:
decode, from the UE, capability information indicating support of the service-based architecture; and
encode, for transmission to the UE, configuration and system information for support of the SBI.
